(19) United States
(12) Patent Application Publication
(10) Pub. No.: US 2006/0165987 A1
(43) Pub. Date: Jul. 27, 2006

(54) Stealthy polymeric biodegradable nanospheres and uses thereof

(76) Inventors: Patrice Hildgen, Quebec (CA); Avedis Panoyan, Quebec (CA); Francois-Xavier Lacasse, Quebec (CA); Richard Quesnel, Quebec (CA); Nevine Rizkalla, Quebec (CA)

Correspondence Address: MERCHANT & GOULD PC, P.O. BOX 2903, MINNEAPOLIS, MN, 55402-0903, US

(21) Appl. No.: 10/510,319

(22) PCT Filed: Apr. 4, 2003
(86) PCT No.: PCT/CA03/00499

§ 371 Date: Jul. 29, 2005

Related U.S. Application Data
(60) Provisional application No. 60/369,838, filed on Apr. 5, 2002.

(51) Int. Cl. B32B 9/02

(52) U.S. Cl. 428/402.2

(57) ABSTRACT

Disclosed herein are stealthy polymeric biodegradable nanospheres each comprising: (i) a polyester-polyethylene multiblock copolymer; (ii) optionally a polyester entangled with the multiblock copolymer to give rigidity to the nanospheres; and (iii) optionally a pharmaceutical compound incorporated therein. Also disclosed is the use of such nanospheres for the preparation of a medicament having a long-term and non-toxic release of a pharmaceutical compound into a mammal, and the method for preparing a stealthy polymeric biodegradable nanospheres.

### BACKGROUND OF THE INVENTION

A) Field of the Invention

The present invention relates to stealthy polymeric biodegradable nanospheres that may be used for delivering therapeutic compounds such as a drug, a protein or a nucleic acid molecule to a mammal. The invention also relates to methods of manufacturing such nanospheres and to methods of drug delivery comprising the use of the nanospheres of the invention.

B) Brief Description of the Prior Art

Controlled release of therapeutic agents is one of the primary objectives in drug formulation. Biodegradable polymers are studied in an increasing number of medical applications and more particularly as drug carriers and in controlled release systems. Polymeric colloidal drug carriers have been of great interest for the preparation of controlled release dosage forms designed for both parenteral and non-parenteral delivery.

However, despite the multitude of carriers that have been prepared, the major drawback with the traditional carriers, either polymeric nanoparticles or liposomes, is their rapid elimination from the bloodstream by the phagocytic cell system. Traditional polymeric carriers are rapidly sequestered into the liver, spleen, kidneys, and reticulo-endothelial system. Also, polymeric carriers typically possess enhanced immunogenicity, cardiovascular and hematological adverse events.

There is thus a need for stealthy polymeric biodegradable nanospheres and methods for synthesizing the same. More particularly, there is a long felt need for nanospheres that can avoid phagocytic uptake. There is also a need for nanospheres having an increased water solubility, a reduced renal clearance, and a decreased toxicity. It would be highly desirable to be provided with nanospheres suitable for the delivery of pharmaceutical compounds into mammals.

The present invention fulfils these needs and also other needs which will be apparent to those skilled in the art upon reading the following specification.

### SUMMARY OF THE INVENTION

Thus a first object of the present invention is to provide a stealthy polymeric biodegradable nanospheres each comprising:
(i) a polyester-polyethylene multiblock copolymer;
(ii) optionally a polyester entangled with the multiblock copolymer to give rigidity to the nanospheres; and
(iii) optionally a pharmaceutical compound incorporated therein.

A second object of the invention is to provide a use of stealthy polymeric biodegradable nanospheres according to the invention for the preparation of a medicament having a long term, controlled and non-toxic release of a pharmaceutical compound into a mammal.

A third object of the invention is to provide a polyester-polyethylene multiblock copolymer of formula (III):
ABA-B′-(ABA-B′)ₙ-ABA (III)

wherein

A is a polyester;

B is a polyethylene;

B′ is a dicarboxylic polyethylene; and

n is a number equal or greater than 2.

A fourth object of the invention is to provide a method for preparing the polyester-polyethylene multiblock polymer of formula (III) according to the invention, comprising the steps of:
a) oxidizing both terminal hydroxyl groups (—OH) of a polyethylene glycol into corresponding carboxylic groups (COOH) by means of a Jones reaction;
b) chlorinating the carboxylic functions of the polyethylene glycol obtained in step a) by making use of a SOCl₂ reagent so as to obtain a polyethylene glycol with terminal dichloride acid functions; and
c) reacting the polyethylene glycol having terminal dichloride acid functions obtained in step b) with the PLA-PEG-PLA triblock polymer obtained in claim 34 by making use of polycondensation reaction so as to obtain a multiblock copolymer according to the invention.

A fifth object of the invention is to provide an improved method for preparing a PLA-PEG-PLA multiblock copolymer of formula (I):
ABA-(c-ABA)ₙ-c-ABA (I)

wherein

n is a number equal or higher than 2;

ABA is a PLA-PEG-PLA triblock; and

c is a carboxylic diacid.

said method comprising the steps of:
a) preparing a PLA-PEG-PLA triblock;
b) mixing the PLA-PEG-PLA triblock prepared in step a) with a diacid of formula (II):

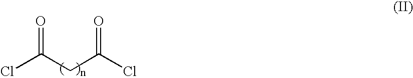

wherein n is a number equal to or greater than 1; and
c) subjecting the mixture of step b) to a polycondensation reaction with the presence of a dicyclohexylcarboxydiimide catalyst and/or a chemical equivalent thereof, said catalyst improving the efficiency of the reaction, thereby allowing to obtain the requested multiblock copolymer.

A sixth object of the invention is to provide a method for delivering a pharmaceutical compound into a mammal, said method comprising the step of:

administering to the mammal a stealthy polymeric biodegradable nanosphere according to the invention loaded with a therapeutically effective amount of the pharmaceutical compound.

A seventh object of the invention is to provide a method for preparing stealthy polymeric biodegradable nanospheres from an emulsion, the method comprising the step of:
(i) preparing an organic internal phase comprising a pharmaceutical compound, a polyester-polyethylene multiblock according to the invention and/or a blend of polymers and a polyester;
(ii) preparing an aqueous external phase;
(iii) injecting both the organic internal phase of step (i) and the aqueous external phase of step (ii) into a homogenization chamber having an outlet, with or without a surfactant, thereby producing an emulsion at the outlet of the chamber;
(iv) evaporating and/or extracting the phases of step (iii) so as to produce stealthy polymeric nanospheres; and
(v) collecting the stealthy polymeric nanospheres obtained in step (iv) by centrifugation or dialysis.

An advantage with the above-mentioned method for preparing stealthy polymeric biodegradable nanospheres resides essentially in that it is carried out in a continuous mode with single or double emulsions.

Another advantage associated with this method of preparing stealthy polymeric biodegradable nanospheres resides in the fact that it can be carried out in the absence of a surfactant.

An advantage of the present invention is that it provides biodegradable nanospheric carriers that are biocompatible, and which shows stable mechanical and chemical properties in vitro as well as in vivo.

Another advantage of the present invention is that it allows to improve drug delivery by offering a targeted action and/or a prolonged biological effect.

Other objects and advantages of the present invention will be apparent upon reading the following non-restrictive description of several preferred embodiments, made with reference to the accompanying drawings.

### BRIEF DESCRIPTION OF THE DRAWINGS

FIG. 1 is a schematic representation of the preparation of nanospheres according to the invention by a single emulsion process using an ultrasound generator.

FIG. 2 is a schematic representation of the preparation of nanospheres according to the invention by a single emulsion process using a high pressure homogenizer, with or without a surfactant.

FIG. 3 is a schematic representation of the preparation of nanospheres according to the invention by a double emulsion process using both an ultrasound generator and a high pressure homogenizer, with or without a surfactant.

FIG. 4 is a schematic representation of the preparation of nanospheres according to the invention by a double emulsion process using a double high pressure homogenizer, with or without a surfactant.

FIG. 5 is a schematic representation for the preparation of nanospheres according to the invention by a double emulsion process using both a turbine and a high pressure homogenizer, with or without a surfactant.

FIG. 6 is a chemical formula of a multiblock copolymer according to the present invention.

FIG. 7 is a ¹H-NMR spectra of the chemical formula represented in FIG. 6.

FIG. 8 is a computer simulated representation of a copolymer of the present invention showing a clear separation of the PLA and PEG domain.

FIGS. 9 and 10 are AFM images of a copolymer film of the present invention showing a clear segregation between the PEG and PLA blocks.

FIG. 11 is the chemical formula of a multiblock polymer according to the invention.

FIG. 12A is a micrograph representing the nanosphere according to the invention after the release period of twenty-nine days.

FIG. 12B is a micrograph representing a nanosphere according to the invention that underwent degradation in a phosphate buffer at 37° C.

FIG. 13 is a graph representing the weight loss of the bulk polymer used according to the invention.

FIG. 14 is a graph representing the typical pore size distribution of nanospheres according to the invention.

FIG. 15 is a bar graph representing the porosity (con³/g) of nanospheres made of various blends of PLA and multiblock polymers.

FIG. 16 is a graph representing the proliferation of B16 cells in the presence of different components.

FIG. 17 is graph representing the in vitro release of Rhodamine from nanospheres according to the invention in a phosphate buffer at 37° C.

FIG. 18 is a graph representing the plasmatic concentration of Rhodamine after IV injection of nanosphere according to the present invention.

FIG. 19 is a graph representing the concentration of Rhodamine in different organs.

FIG. 20 are bar graphs representing the behavior of phagocytic cells in the presence of stealthy nanospheres according to the present invention.

FIG. 21 is an AFM image of the nanosphere's surface according to the invention.

FIG. 22 is an AFM image of the nanosphere's surface with PEG blocks concentrated thereon.

FIG. 23 are images of the nanospheres according to the invention obtained by a scanning electron microscope.

FIG. 24 is an AFM image of the detailed morphology of the nanosphere according to the invention.

FIG. 25 is a graph representing the particle size distribution of the PLGA nanospheres according to the invention obtained by photon correlation spectroscopy.

FIG. 26 are bar graphs representing the values of surface area and porosity of the nanospheres according to the invention.

FIG. 27 is a graph representing the pore size distribution of the PLGA, PLA, triblock and multiblock nanospheres (right) and for the PLGA nanospheres protected with 0.5%, 1% and 5% sorbitol respectively (right).

### DETAILED DESCRIPTION OF THE INVENTION

### A) GENERAL OVERVIEW OF THE INVENTION

The present invention relates to a novel polyester-polyethylene multiblock copolymer, and to methods of synthesizing and using the same.

The invention also relates to stealthy polymeric biodegradable nanospheres, and to methods of synthesizing and using the same.

### B) SYNTHESIS AND CHARACTERIZATION OF A MULTIBLOCK COPOLYMER

According to one aspect, the present invention provides an improved method for synthesizing a (PLA-PEG-PLA)ₘ multiblock copolymer.

According to another aspect, the present invention provides a novel method for synthesizing a novel polyester-polyethylene glycol multiblock copolymer.

According to another aspect, the present invention provides methods for synthesizing stealthy polymeric biodegradable nanospheres using these two different types of multiblock copolymer.

i) Improved Method for Synthesizing PLA-PEG-PLA Multiblock Copolymer

It is well known in the art how to synthesized triblocks of PLA-PEG-PLA. Typically, these blocks are arranged according to the following manner:
ABA-c-ABA-c-ABA-c-ABA (I)
wherein “ABA” is the PLA-PEG-PLA triblock and “c” is a carboxylic diacid (e.g. butanedioic acid, propanedioic acid, pentanedioic acid (IUPAC nomenclature)).

Monomer A can be obtained from the following compounds:

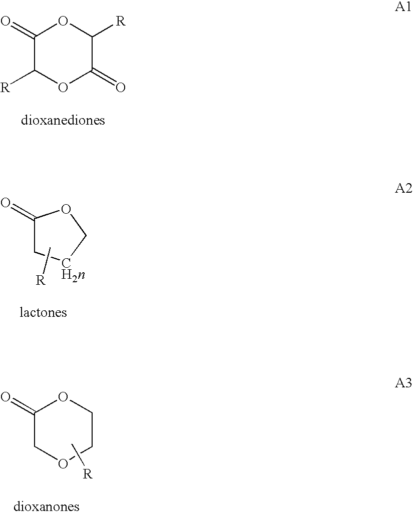

In formulas A1, A2 and A3, R is an alkyl group and n represent a number (n=1, 2 or 3).

Monomer B (PEG) can be obtained from the following compound:

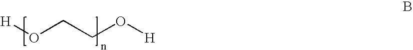

Wherein n represent a number between 200 and 2000.

Typically, the first step consists of mixing together one or several compounds of the A type with a compound of the B type. The compounds are polymerized by polycondensation under an inert atmosphere at a temperature of 160° C. to 180° C. for 2 to 6 hours. A tin-based catalyst such as tin octanoate or tetraphenyltin. The polymer ABA so obtained is dissolved in acetone and precipitated with water. The precipitate is then washed and dried.

The most common method for synthesizing a PLA-PEG-PLA multiblock copolymer from the ABA polymer is the method developed by Dupont in the seventies. Briefly, the ABA triblock polymer is placed in a round bottom flask in presence of a diacid dichloride. Following a polymerization by polycondensation, and elimination of HCl, a multiblock ABA copolymer (ABA-c-ABA-c-ABA-c-ABA) is obtained. Suitable diacid dichloride have the following formula (II):

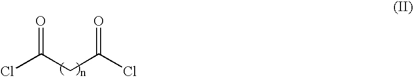

Preferred diacid dichlorides include: propanedioic acid, butanedioic acid, pentanedioic acid, etc.

Interestingly, the present inventors have found that the efficiency of the method is greatly improved when dicyclohexylcarboxydiimide (DCC) is used as a catalyst in the reaction. Therefore, the present invention encompasses the use of DCC as well as chemical equivalents such as EDC for synthesizing a PLA-PEG-PLA multiblock copolymer from ABA polymers.

ii) Novel Polyester-Polyethylene Multiblock Copolymer and Method for Synthesizing the Same

According to another aspect, the invention provides a multiblock copolymer that is composed of alternate blocks of polyester and of polyethylene glycol. According to the invention, these blocks are arranged according to the following manner:
ABA-B′-ABA-B′-ABA-B′-ABA (III)
wherein A is a polyester, B is a polyethylene glycol and B′ is a dicarboxylic polyethylene.

A non-exhaustive list of suitable polyesters includes polylactic acid (PLA); polylactic-co-glycolic acid (PLGA); polycaprolactone (PCL), and polyhydroxy butyrate. A non-exhaustive list of suitable polyethylenes includes polyethylene oxides (PEO) such as polyethylene glycol (PEG). A non-exhaustive list of suitable dicarboxylic polyethylene includes dichlorine dicarboxylic PEG and dibromine dicarboxylic PEG. More preferably, the polyester consists of PLA, the polyethylene consists of PEG and the dicarboxylic polyethylene consists of dichlorine dicarboxylic PEG.

Preferably, the multiblock copolymer is synthesized by using PEG as the polyethylene. According to this embodiment, commercially available PEG is oxidized into a dicarboxylic PEG, then a dichloride acid is formed:

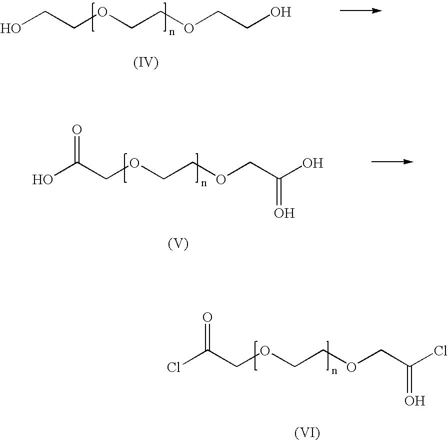

The first step consists of an oxidation with Jones' reactive, and the second a chlorination by SOCl₂.

The dichloride acid obtained is then polycondensed with a ABA triblock copolymer obtained as described previously (PLA-PEG-PLA) and HCl is eliminated. The final product is a multiblock copolymer (ABA-B′-ABA-B′-ABA-B′-ABA) having a number of sequences which varies according to the proportions of the initial compounds in the reaction.

iii) Methods for Synthesizing Stealthy Polymeric Biodegradable Nanospheres

According to another aspect of the present invention, the two different types of multiblock copolymers described hereinbefore are used for synthesizing stealthy polymeric biodegradable nanospheres useful for drug delivery purposes.

The different embodiments described hereinafter are variants of a technique consisting of making an oil/water or a water/oil/water emulsion, depending on the solubility of the constituents into the organic or aqueous phase. One of the novel aspects of the methods of the invention lies in a continuous procedure and in the absence of a surface active agent.

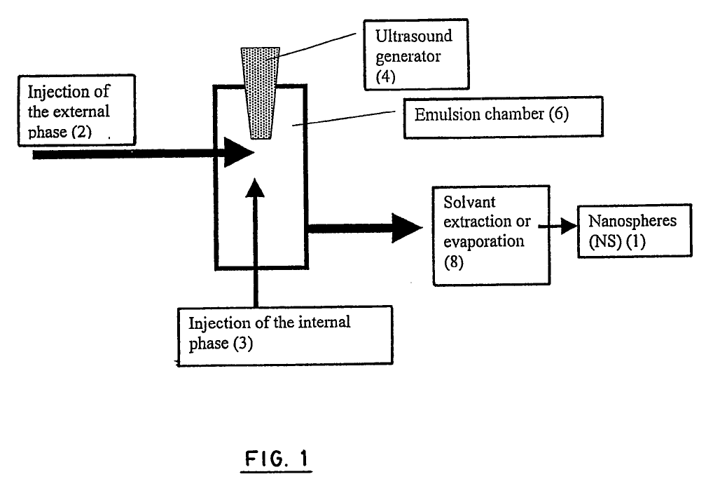

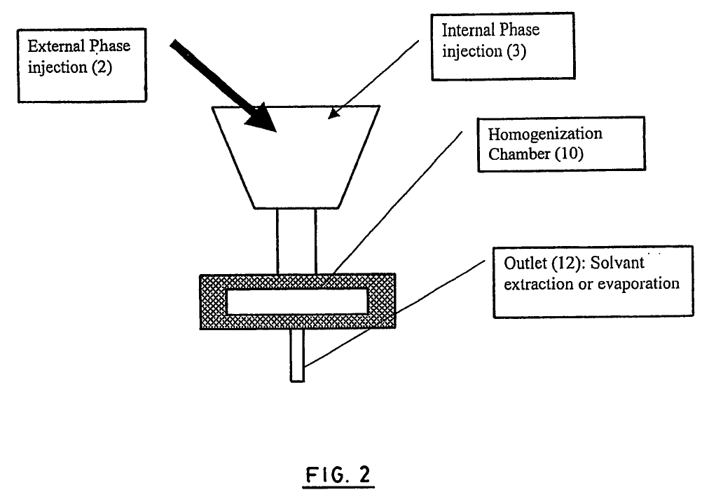

According to a preferred embodiment, a mixture comprising an organic solvent (e.g. chloroform, methylene chloride or ethyl acetate), a suitable pharmaceutical compound and a multiblock polymer or a blend of polymers (a multiblock polymer mixed with a polyester such as PLA, PCL or PLGA) is prepared by dissolution at room temperature. The mixture so produced comprises an organic internal phase and an aqueous external phase. Both phases are separated and the organic internal phase is injected into a homogenizer simultaneously with the aqueous external phase. The homogenizer outlet comprises nanoparticles in development (See FIGS. 1 and 2). The solvent is evaporated or extracted and the nanoparticles are recovered by centrifugation or dialysis.

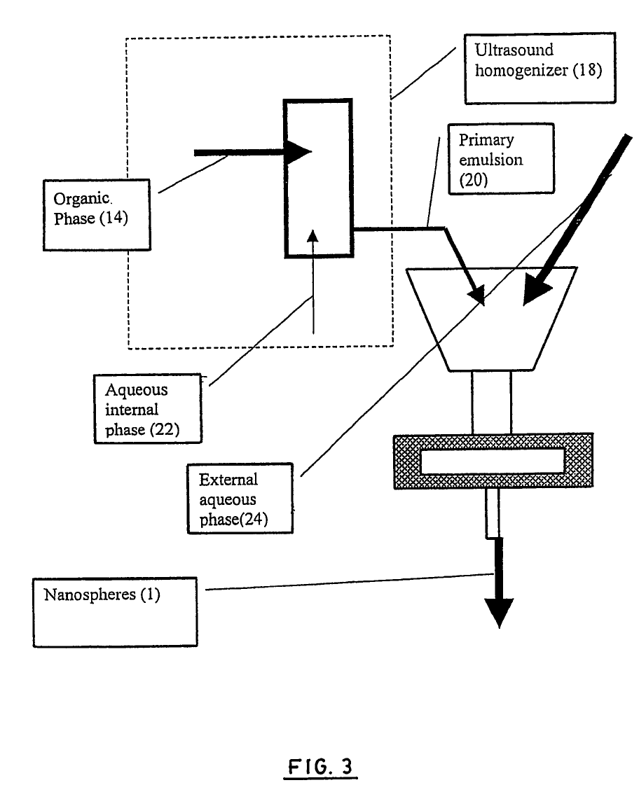

According to another embodiment, the method consists of a double emulsion (water/oil/water). A first emulsion is made by dispersing an internal aqueous solution comprising the suitable pharmaceutical compound into an organic solution of a multiblock polymer (or a blend of polymers). Then this primary emulsion is poured in the external aqueous phase to obtain the secondary emulsion. (See FIGS. 3 to 5).

FIG. 1: Schema for the preparation nanoparticles by single emulsion process using ultra-sound.

FIG. 2: Schema for the preparation nanoparticles by single emulsion process using a high pressure homogenizer, with or without a surfactant.

FIG. 3: Schema for the preparation nanoparticles by a double emulsion process using ultra-sound and a high pressure homogenizer, with or without a surfactant.

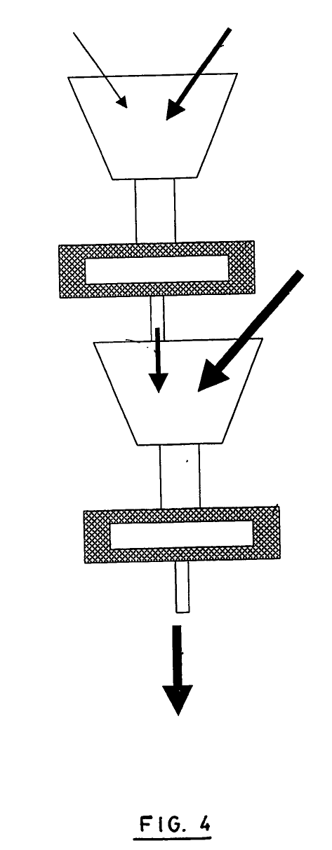

FIG. 4: Schema for the preparation nanoparticles by a double emulsion process using a double high pressure homogenizer, with or without a surfactant. According to this process, a primary emulsion is obtained in a first homogenization. The primary emulsion is then fed for a second homogenizing step together with the external aqueous solution.

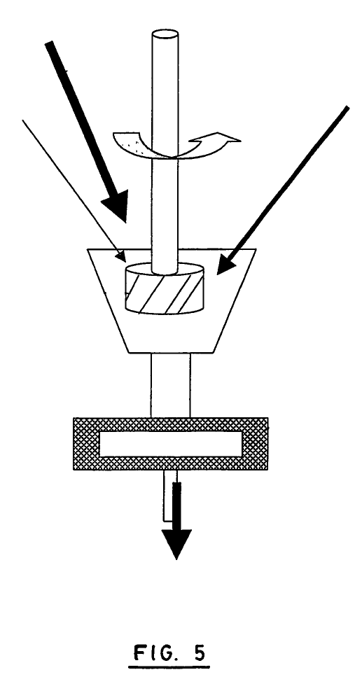

FIG. 5: Schema for the preparation nanoparticles by a double emulsion process using a turbine and a high pressure homogenizer, with or without a surfactant.

### B) CHARACTERISTICS OF THE STEALTHY POLYMERIC BIODEGRADABLE NANOSPHERES

The stealthy polymeric biodegradable nanospheres of the present invention comprise (i) a multiblock copolymer and (ii) a polyester. For drug delivery purposes, the nanospheres further comprise (iii) a pharmaceutical compound such as a drug, a protein, a peptide and/or a nucleic acid molecule.

i) Polyester-Polyethylene Multiblock Copolymer

Preferably, the nanospheres comprise about 0.1% to 99% of the polyester-polyethylene multiblock copolymer. The multiblock copolymer consists of a series of blocks of polymers which alternates to form a repetitive sequence. According to one embodiment, the multiblock copolymer is composed of alternate triblocks of polylactide (PLA) and polyethylene glycol (PEG) having the following formula:

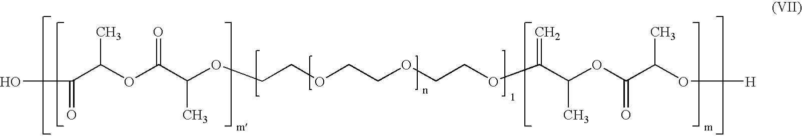

According to this embodiment, these blocks are arranged according to the following manner:
ABA-c-ABA-c-ABA-c-ABA (I)
wherein “ABA” is the PLA-PEG-PLA triblock and “c” is a carboxylic diacid (e.g. butanedioic acid, propanedioic acid, pentanedioic acid (IUPAC nomenclature)).

According to another, more preferred embodiment, the multiblock copolymer is composed of alternate blocks of polyester and polyethylene glycol. According to this embodiment, these blocks are arranged according to the following manner:
ABA-B′-ABA-B′-ABA-B′-ABA (III)
wherein A is a polyester, B is a polyethylene glycol and B′ is a dicarboxylic polyethylene.

A non-exhaustive list of suitable polyesters includes polylactic acid (PLA); polylactic-co-glycolic acid (PLGA); polycaprolactone (PCL), and polyhydroxy butyrate. A non-exhaustive list of suitable polyethylene includes polyethylene oxides (PEO) such as polyethylene glycol (PEG). A non-exhaustive list of suitable dicarboxylic polyethylene includes dichlorine dicarboxylic PEG and dibromine dicarboxylic PEG. More preferably, the polyester consists of PLA, the polyethylene consists of PEG and the dicarboxylic polyethylene consist of dichlorine dicarboxylic PEG.

ii) Polyester

Preferably, the nanospheres comprise about 0.1% to 99% of a polyester. The polyester, entangled with the multiblock copolymer, is useful for increasing the rigidity of the nanospheres. A non-exhaustive list of suitable polyester includes polylactic acid (PLA); PLG, PCL or their copolymers. More preferably, the polyester consists of PLA.

(iii) Pharmaceutical Compound

The main anticipated use of the nanospheres of the present invention is for the delivery of a pharmaceutical compound into a mammal. Therefore, the nanospheres preferably comprise a pharmaceutical compound that is dispersed into the nanospheres.

A non-exhaustive list of pharmaceutical compounds that could be incorporated into the nanospheres of the present invention includes drugs, proteins, peptides and/or a nucleic acid molecules. Therefore, the nanospheres of the present invention could be used for the prevention or treatment of various diseases and more particularly for the delivery of different types of therapeutic agents such as anticancer agents (e.g. doxorubicine, taxol, vincristine, etc.), immunosuppressive agents, agents for steroid therapy, anti-arrhythmic agents (e.g. propafenone), antibiotics, antiparasitics, antivirals, antifungics, gene therapy agents (e.g. plasmid), antisense molecules, orphan drugs, vitamins, etc. Of course, the nanospheres may further comprise other agents such as antibodies and the like for a targeted delivery of the pharmaceutical compound.

The amount of pharmaceutical compound present in the nanospheres of the present invention is a therapeutically effective amount. A therapeutically effective amount of pharmaceutical compound is that amount necessary so that the nanospheres performs its desired therapeutic effect without causing overly negative effects in the host to which the nanospheres are administered. The exact amount of pharmaceutical compound to be used and nanospheres to be administered will vary according to factors such as the pharmaceutical compound biological activity, the type of condition being treated, the mode of administration, as well as the other ingredients in the composition. Preferably, the nanospheres will comprise from about 0.1% to 20% of the pharmaceutical compound.

Any appropriate route of administration may be employed, for example, administration may be parenteral, intravenous, intraarterial, subcutaneous, intramuscular, intracranial, intraorbital, ophthalmic, intraventricular, intracapsular, intraspinal, intracisternal, intraperitoneal, intranasal, aerosol, by suppositories, or oral administration. Nanospheres therapeutic formulations may be in the form of liquid suspensions; for oral administration, formulations may be in the form of tablets or capsules; and for intranasal formulations, in the form of powders, nasal drops, or aerosols.

iv) General Characteristics of the Nanospheres

Preferably, the nanospheres of the invention have an average size of less than 800 nm. Preferably, their size is about 200 nm to 10 μm and more preferably about 100 nm to 5 μm. Preferably also, the nanospheres have a zeta potential close to 0 mV.

As it will be shown hereinafter in the exemplification section, the nanospheres of the present invention have stealth capabilities. Indeed, they are “invisible” to the immune system so they can be injected into a mammal without being detected by phagocytes (macrophages, monocytes, mastocytes) during the whole period they remain in the organism. Also, the nanospheres do not accumulate in the organs of the reticular endothelial system (spleen, liver, kidney). Furthermore, given their nanosize, the nanospheres can circulate through the vascular system without causing any embolus.

Therefore, the nanospheres of the present invention may be used for a long term, controlled and non-toxic release of a pharmaceutical compound into the blood stream or in the tissues of a mammal. According to an embodiment, the in vitro release of the pharmaceutical compound occurs over a period of a hundred of hours. According to another embodiment, the in vivo release of the pharmaceutical compound is controlled and pulsed.

### EXAMPLES

The following examples are illustrative of the wide range of applicability of the present invention and are not intended to limit its scope. Modifications and variations can be made therein without departing from the spirit and scope of the invention. Although any methods and materials similar or equivalent to those described herein can be used in the practice for testing of the present invention, the preferred methods and materials are described.

### Example 1

### Synthesis and Characterization of Novel PLA-PEG Multiblock Copolymer

Introduction

Biodegradable polymers are studied in an increasing number of medical applications. They are used as drug carriers, controlled release systems, etc. Some authors are interested in the possibilities that a copolymer consisting of polylactic acid (PLA) and polyethylene glycol (PEG) can offer. A multiblock copolymer composed of PLA and PEG is of considerable interest as a drug carrier, since the PLA segments could provide rigidity, while the PEG portions confer stealth behavior (R. H. Muller. CRC Press Inc., Boca Raton, Fla., 1991: 45-46). PEG can offer a certain degree of hydrophilicity to the polymer that can be useful if we want to use it as a carrier for an hydrophilic drug. But the current ring-opening polymerization of (D,L)-lactide in the presence of PEG can only produce an A-B-A triblock copolymer where the B block (PEG) is trapped between two A blocks (PLA).

We propose here an efficient synthesis method for a polyester-polyethylene multiblock copolymer where the polyester (A) blocks alternate with polyethylene (B) blocks to form a repetitive sequence.

Experimental Methods

i) Materials

Polyethylene glycol (molecular weight 400), (D,L)-lactide, tetraphenyltin and adipic acid were purchased from Aldrich Chemical Company, Inc. (Oakville, Ont., Canada) and were dried under vacuum in the presence of phosphorus pentoxide for 24 hours prior to use. N,N-dimethylformamide was distilled over calcium hydride and kept on a 4 Å molecular sieve prior to use. Thionyl chloride and pyridine were used as received from Aldrich Chemical Company.

ii) Preparation of Triblock PLA-PEG-PLA Copolymer

The triblock polymer was synthesized by a ring-opening polymerization of (D,L)-lactide in the presence of PEG, as described by Cohn and Younes (J. Biomed. Mater. Res. 22(11): 993-1009 (1988)). PEGs with different molecular weight were used. Briefly, 8.3 mmol of PEG (molecular weight 200, 400 or 1500) were added to 158.3 mmol of (D,L)-lactide (molecular weight 144.13) in a round bottom, single neck flask. Tetraphenyltin 0.01% was used as a catalyst. The reaction was carried at 180° C. for 6 h under an argon-inert atmosphere. The resulting polymer was precipitated in water from acetone, removing any un-reacted PEG or (D,L)-lactide. The polymer was then dried under vacuum with phosphorus pentoxide.

iii) Preparation of a Multiblock (PLA-PEG-PLA)ₙ Copolymer

The triblock copolymer (3 mmol) and adipic acid (3 mmol) were dissolved in N,N-dimethylformamide (40 ml) under an argon-inert atmosphere. A solution of thionyl chloride (15 mmol) in pyridine (15 ml) was added at 0° C. over a period of 30 minutes. The temperature was brought to 20° C. over a period of 10 hours, under magnetic stirring. The polymer was then precipitated in water and washed several times to remove any trace of solvent. Its structure is shown in FIG. 1.

iv) Contact Angle Measurements

Contact angle measurements were made using a Tantec CAM-MICRO™ contact angle meter. For each copolymer, 200 mg was dissolved in 3 ml of dichloromethane, and a thin film was cast on a glass slide. The films were dried under vacuum to remove any trace of solvent. Polylactic acid was used as a reference for the contact angle measurement. Contact angle measurements were made at 0 and 420 seconds.

Results and Discussion

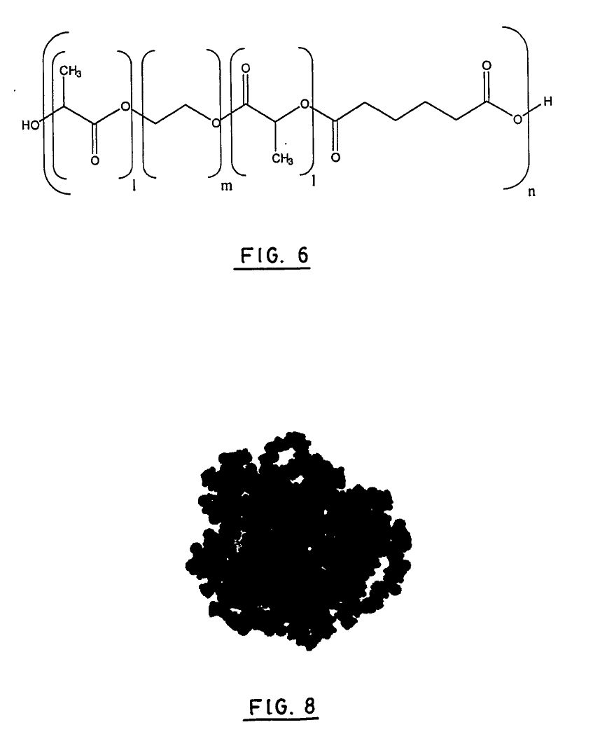

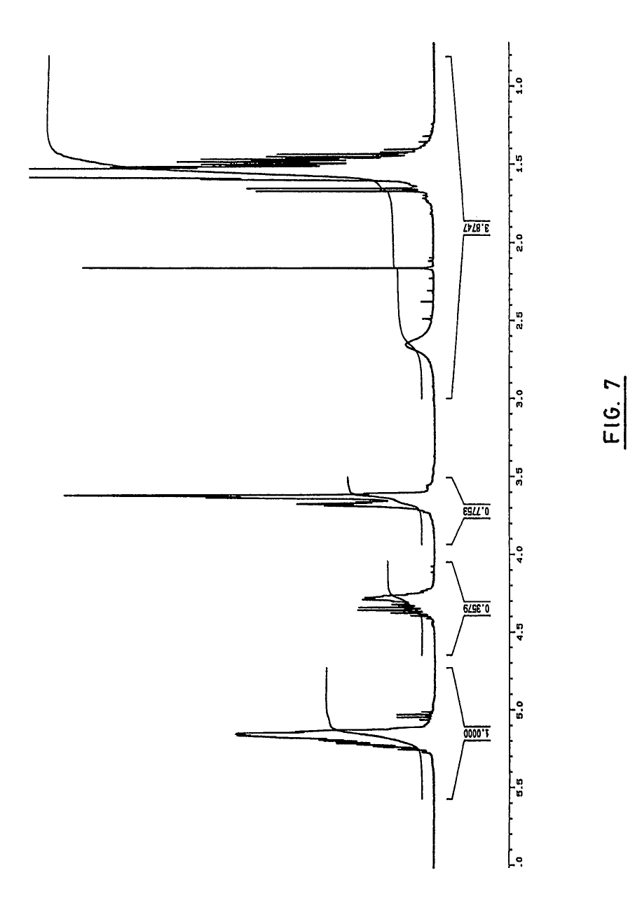

¹H-NMR, using a Bruker 400 MHz spectrometer showed a typical spectrum for the triblock copolymer with peaks at 5.2 ppm corresponding to the tertiary PLA proton, at 3.6 ppm for the protons of the repeating units in the PEG chain, at 4.3 ppm for the PEG connecting unit to the PLA block, and at 1.5 ppm for the pendant methyl group of the PLA chain (not shown). For the multiblock copolymer showed in FIG. 6, peaks corresponding to the protons in the adipic acid chain were detected at 3.0 and 2.3 ppm (see FIG. 7).

Molecular weight (Table 1) was mesured by gel permeation chromatography using a Waters™ spectrometer. Molecular weight around 2000 Da for the triblock copolymer and 10 000 Da for the multiblock copolymer showed that the blocks were covalently bounded together.

TABLE 1
Molecular weight measurements

| | Mn | Mw | I |
|---|---|---|---|
| TRIBLOCK | | | |
| PEG 200 | 1474.17 | 2151.45 | 1.46 |
| PEG 400 | 900.84 | 1285.34 | 1.43 |
| PEG 1450 | 2835.22 | 3595.42 | 1.27 |
| MULTIBLOCK | | | |
| PEG 200 | 4357.02 | 9657.48 | 2.22 |
| PEG 400 | 3646.71 | 8537.77 | 2.34 |
| PEG 1450 | 6607.95 | 12040.6 | 1.82 |

Contact angle measurements (Table 2), show that the copolymerization of PLA with PEG reduce the contact angle thus augmenting the hydrophilicity of the copolymer compared to PLA alone.

TABLE 2
Contact angle measurements

| | Contact angle | Contact angle |
|---|---|---|
| Polymer | (t = 0 s) | (t = 420 s) |
| PLA | 73.7 | 49.3 |
| Multiblock (PEG 200) | 59.6 | 38.6 |
| Multiblock (PEG 400) | 19.2 | 2.0 |
| Multiblock (PEG 1450) | 17.6 | 0.6 |

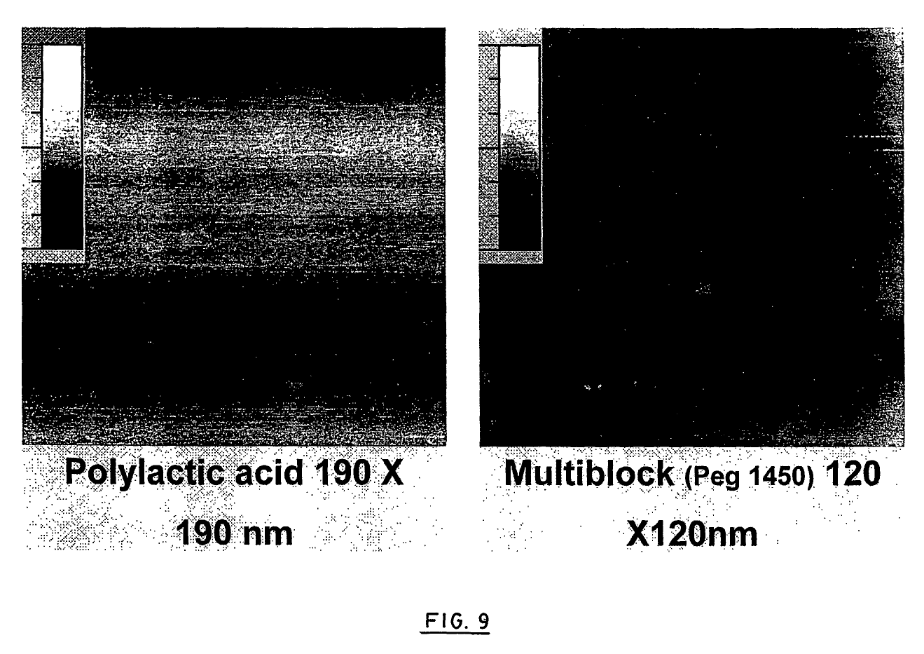

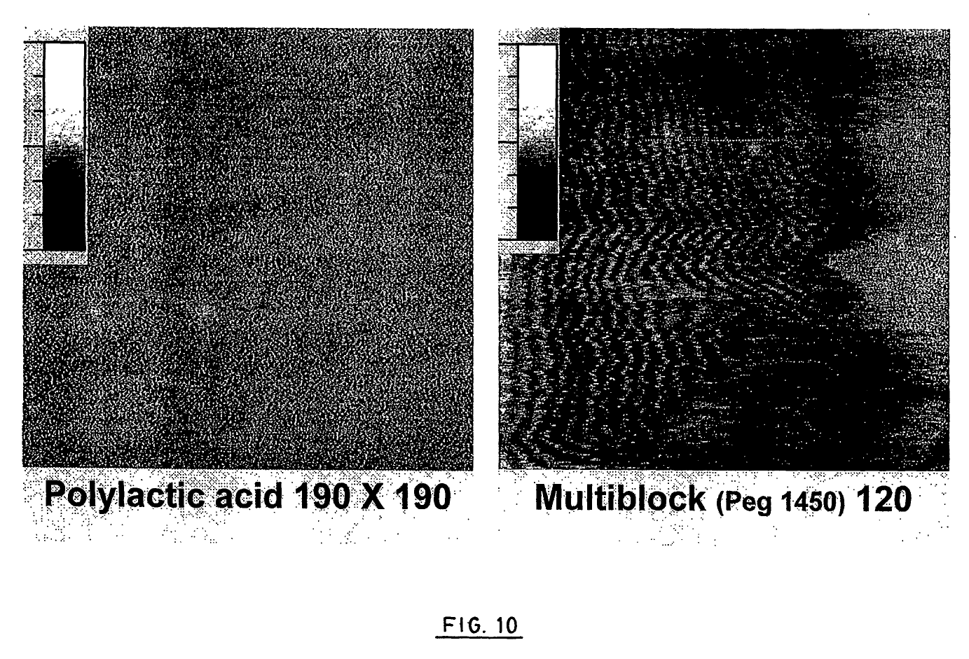

In computer simulation (FIG. 8), the copolymer tends to show clear separation of the PLA and PEG domains. This spatial organization is confirmed by AFM Phase imaging microscopy of a copolymer film (FIGS. 9 and 10) showing a clear segregation between the PEG and PLA blocks.

Conclusion

We were able to synthesize a multiblock PLA-PEG copolymer in a two step high yield synthesis. A significant reduction of contact angle, showing an increase in hydrophilicity, is measurable with only 5% molar ratio of PEG versus (D,L)-lactide. These results suggest that the copolymers have a strong potential as a biocompatible drug carrier.

### Example 2

### Injectable Nanospheres from a Novel Multiblock Copolymer: Cytocompatibility, Degradation and in vitro Release Studies

Introduction

Recently, polymeric drug delivery systems have been extensively investigated as long term and controlled release devices. Such systems, which are in the form of microcapsules, microparticles, or nanoparticles, are found to be useful carrier systems for many drugs (indomethacin, piroxicam), ciprofloxacin, gentamycin, antineoplasic agents (cisplatin, adriamycin), proteins (bovine serum albumin, interleukin-2), and vaccines (tetanus, diphtheria toxoid). As injectable drug carrier systems, nanospheres (NS) made of polymers are the most used colloidal devices. They are solid particles ranging in size from 10 nm to 1000 nm. The NS are stable drug delivery forms compared with other systems such as liposomes which present some inconveniences such as limited physical stability as well as poor drug loading capacities. Since the NS provide sustained release of drugs, they have a promising therapeutic interest. Polymeric NS can be administered via different routes such as intravenous, intramuscularly and subcutaneous injection as well as oral, ophthalmic and even transdermal administration. The NS must possess important characteristics, as size, shape, surface charge, and hydrophilicity that are critical in drug delivery and avoidance of mononuclear phagocyte system (MPS). The in vivo distribution of the NS is affected by their size, surface charge and hydrophilicity, as they should be small enough to freely circulate through the capillaries, since large particles are rapidly cleared from blood by capillary filtration mainly in the lungs. The shape of the NS may be involved in toxicity. Cellulose fibers have been shown to be toxic causing embolism and death compared to large microspheres that were well tolerated. The physical stability and blood opsonization are affected by the surface charge of the vector. Particles with high negative charges are quickly removed from blood circulation by the MPS. On the other hand, neutral surface charge and hydrophilic coating of the NS reduce particle blood clearance and recognition by phagocytic cells.

Biocompatible and biodegradable polymers, especially polylactide (PLA), poly-DL-lactide-coglycolide (PLGA) and poly-DL-lactide-copoly (ethyleneglycol) (PELA), are the most widely studied biomaterials in the form of injectable or implantable systems. As drug carriers they allow slow release, targeting, lower side effects, greater patient compliance, greater efficacy of treatment and protection of labile drugs.

The polymers of choice in the manufacturing of injectable nanospheres are the ones composed of PLA and PEG. PLA is biodegradable, but the major obstacle is the rapid uptake by the MPS. A multiblock copolymer composed of PLA and PEG is of considerable interest as a drug carrier, since the PLA segments will provide rigidity, while the PEG portions will confer a stealth behavior to the polymers. The PLA chains will form the hard core of the NS, while the PEG chains will be located mainly on the surface to form a dynamic molecular shield over the NS surface. The presence of hydrophilic segments on particle surface and the electrical neutrality enhances the biocompatibility of the multiblock copolymer. The incorporation of PEG with PLA renders the attachment of PEG stronger and thus not removable by washing steps.

Presently, several studies have been conducted on blends of PLA and PEG as drug vectors. PEG-coated NS and micelles were prepared from PLA-PEG diblock. Non-linear multiblock polymer composed of n-PEG chains and hydrophobic chains have been synthesized to increase the PEG density. The synthesis of a novel linear multiblock polymer made of PLA and PEG will possess an increased physical stability. The hydrophilic PEG chains will be less oriented since they will be anchored to the PLA block conferring rigidity. Hence PEG chains will not be washed away either will form channels during NS formation and during the release. When PEG chains are free, they behave like a surfactant (PVA), being located on the surface. Moreover, it has been shown that amphiphilic copolymers will aggregate to form micelles. Diblock copolymers of PEG-ε-caprolactone form micelles easier than the triblock copolymers, hence the multiblock copolymer will possess enhanced efficiency for NS preparation. It is of growing interest to study the behavior of this new class of multiblock (-PLA-PEG-PLA-)ₙ copolymer as a drug carrier for prolonged release of anti-infectious or anti-neoplasic drugs. Prior to be used as a new biomaterial, cytocompatibility and degradation studies must be conducted for safety.

Hence, the objectives of this study were to 1) conduct in vitro cytotoxicity tests on the new biomaterial; 2) manufacture NS from the (-PLA-PEG-PLA-)ₙ multiblock copolymer; and 3) report the physico-chemical properties of the NS with regard to the size, zeta potential, porosity and hydrophilicity. Furthermore, incorporation of Rhodamine B as a drug model in the NS and its in vitro release were studied to assess the potential of these NS as a drug carrier.

Materials and Methods

Materials

Rhodamine B was purchased from Sigma (St Louis, Mo., USA). Chloroform was obtained from Anachemia (Montreal, Qc, Canada). Poly (vinylalcohol) 80% hydrolyzed, sodium hydrogenophosphate 98%, sodium chloride 98%, and sodium azide were from Aldrich Chemical Company Inc., Minimum Essential Medium, Pyruvate substrate, Sigma color reagent, gentamycin, and MTT (dimethyl thiazoldiphenyltetrazoliumbromide) were from Sigma (St Louis, Mo., USA). Hanks' Balanced Salt Solution, fetal bovine serum, and trypsin-EDTA were obtained from Gibco Life Technologies (Burlington, Canada). Tetraphenyltin, adipic chloride, and pyridine were purchased from Aldrich (Oakville, ON, Canada).

2) Polymer Synthesis

A triblock polymer was first synthesized by a ring-opening polymerization of (DL)-Lactide in the presence of polyethylene glycol (PEG), as described by Cohn and Younes (J. of Biomredical Materials Res. 22: 993-1009 (1988)). Briefly, 8.3 mmol of PEG (molecular weight 400) was added to 158.3 mmol of (DL)-Lactide (molecular weight 10000) in a round bottom single neck flask. Tetraphenyltin was used as a catalyst in a proportion of 0.01%. The reaction was carried at 180° C. for 6 hours under an argon inert atmosphere. The resulting triblock polymer was then linked into a multiblock chain by the use of adipic chloride as the linking agent with pyridine as solvent. The multiblock polymer structure is shown in FIG. 11. After completion of the reaction, the multiblock copolymer was washed several times to remove any trace of residual solvent.

3) Nanospheres Preparation

NS were prepared using a modified emulsion solvent evaporation method: the organic phase was prepared as follows: Rhodamine B (20 mg) was dissolved in 10 ml chloroform containing different blends of PLA and a (-PLA-PEG-PLA-)ₙ multiblock copolymer (100 mg) of each. The drug polymeric solution was slowly injected (1 ml/min) with a syringe from the bottom outlet into the chamber (cylindrical stainless steel tube with three outlets and containing the sonication microtip immersed from the top) to prepare the emulsion. The aqueous phase containing 0.5% poly (vinylalcohol) PVA was pumped continuously (3 ml/min) into the chamber from a conical flask (500 ml) at the left side outlet. The emulsion is recovered from the right outlet in a beaker. The advantage of the continuous emulsion formation is the possibility of scaling up.

The emulsification was achieved by ultrasonication (continuous mode: 180 s, amplitude control of ultrasonic vibration: 5, power output: 15%) using a sonic probe fitted with a tip in the mixing chamber (Sonic Dismembrator model 550™ from Fisher Scientific Company, Pittsburgh, Pa.). The suspension of NS was magnetically stirred (150 rpm) thereafter for 2 hours under low vacuum in order to remove the organic solvent.

After centrifugation of the suspension (10000 rpm, 20 min) the NS were washed 3 times with distilled water to remove the undesired preparation additives (PVA). The NS were obtained as purple powder by fast freeze-drying (vacuum condition: 0 to 5 microns Hg, temperature: −100 to −50° C.) for 48 hours and were stored in desiccator at 4° C.

4) Nanospheres Characterization

Size, Zeta Potential, and Morphology

The mean size of the NS was determined using photon correlation spectroscopy (N4 Plus, Coulter Electronics Inc., Hialeah, Fla.). NS were suspended in a phosphate buffer at pH 7.4 to give a particle count rate between 5×10⁴ and 1×10⁶ counts per s. Experimental conditions were: temperature 25° C.; refractive index 1.33; viscosity 9.3×10⁴ kg.m⁻¹.s⁻¹; angle of measurement 90° C.; sample run time 90 s.

The NS charge, determined as the zeta potential (ξ), was measured in phosphate buffer by Doppler electrophoretic light scattering with a coulter DELSA 440 SX. The NS (5 mg) were suspended in the phosphate buffer at pH 7.4, molarity 0.15 and ionic strength 0.26.

The morphological characterization of the NS was performed using scanning electron microscopy (SEM). The NS were attached to the aluminum sample holder by a double-sided adhesive tape. The samples were coated with a layer of gold for 3 min using a sputter coater (Edwards Auto 306). Samples were examined with a Jeol model SEM (JSM-820™, Jeol) at 25 KV.

b) Drug Loading, Yield and Entrapment Efficiency

Rhodamine loading in the NS was determined by dissolving 5 mg of NS in 5 ml of chloroform. The Rhodamine content of each sample was analyzed using a UV spectrophotometer HP 8452A Diode Array Spectrophotometer™ at 543 nm. A calibration curve was generated using Rhodamine standard dissolved in chloroform.

$$Drug loading ( \% ) = \frac{amount of drug in nanospheres}{amount of nanospheres}$$

The yield was calculated as the weight of the dried NS in relation to the sum of the starting materials.

$$Yield ( \% ) = \frac{total weight of nanospheres obtained}{total weight of initial raw materials}$$

$$Entrapment efficiency ( \% ) = \frac{amount of drug loaded}{initial amount of drug}$$

c) Degradation Study

For each time interval, weighed amount of the multiblock copolymer (100 mg) was prepared in separate tubes. 10 ml of phosphate buffer was added to each sample and was placed in a shaking water bath at 37° C. At various time intervals, the sample was centrifuged (5000 rpm, 10 min) and the supernatant was discarded. The residue was washed 3 times with water and freeze dried for 24 hours to remove the phosphate buffer. 2 ml of chloroform was added to the dry residue to dissolve the remaining polymer, filtered and then evaporated at 37° C. on a rotavapor. The weight of the remaining polymer was measured.

d) Porosity Determination

To determine the porosity and pore-size distribution of NS, a Coulter SA 3100™ gas sorption analyser was used. The amount of samples ranged between 100 mg and 200 mg. Briefly, the samples were gassed out at 298 K for 30 min prior to analysis at 77 K. Pore volume distributions were calculated according to the Barrett-Joyner-Halenda (BJH) method. The total pore volume was obtained by converting the amount adsorbed at a relative pressure of 0.99 to the volume of required adsorbate.

5) Cytocompatibility Studies

a) Cell Line

B16-F1 mice melanoma cells (American Type Culture Collection) (Rockville, Md.) were cultured in MEM supplemented with 10% heat inactivated fetal bovine serum and gentamycin (0.5 μg/ml). Cells were placed in tissue culture flasks and incubated at 37° C. in an atmosphere of 5% carbon dioxide.

b) MTT Assay (dimethyl thiazoldiphenyltetrazoliumbromide)

B 16-F1 cells were suspended in final concentration of 5×10⁵ cell/ml and plated (100 μl/well) in 96-well flat-bottomed microtiter plates. Raw materials and NS were then added (10 μl) at the following concentrations: (500, 50, 5 and 0.5 μg/well). Sterile pyrogen-free NaCl (0.85%) was used to prepare all solutions. The plates were incubated for a total of 48 hours. After 48 hours, viable cell growth was determined by MTT assay. MTT was dissolved in phosphate buffer (5 mg/ml) and filtered to sterilize the MTT solution. 10 μl of MTT solution per 100 μl of medium was added to each well. After 4 hours, at 37° C., 100 μl of isopropanol acid (0.04 N HCL in isopropanol) was added to all wells and mixed to dissolve the dark blue crystals (26). Cleaved MTT to formazan was measured at a wavelength of 570 nm. The experiments were in triplicate and repeated 3 times. Cell growth was calculated from the following equation:

$$Cell growth = \frac{optical density of treated cells}{measured optical density of control well} \times 100$$

c) LDH (Lactate dehydrogenase) Assay

LDH in the supernatant was used as an indicator of cell death and was determined by means of a commercial kit (Lactate Dehydrogenase, Sigma Diagnostics). Briefly, 4 μl of the supernatant was deposited on an ELISA plate. 20 μl of NADH solution was added in each well for 30 min and incubated at 37° C. Then 20 μl of Sigma color reagent was added and left for 25 min at room temperature. 200 μl of NaOH (0.4 N) was added and read at 450 nm within 5 min. Total LDH activity was measured by incubating NS in 1.0% v/v Triton-X100 in water to induce lyses followed by vigorous agitation.

6) In vitro Release Studies

The in vitro Rhodamine release profiles from the (-PLA-PEG-PLA-)ₙ multiblock NS were determined as follows: NS were precisely weighed and suspended in 10 ml of phosphate buffer solution. The NS suspension was introduced into a dialysis membrane bag (Spectra/por™, Molecular weight cut off: 2000-4000, Spectrum Medical Industries, Inc., CA, USA) that was placed in 150 ml of phosphate buffer. This solution was stirred at 37° C. At pre-determined time intervals, 3 ml aliquots of the release medium were withdrawn from the release medium. The release of Rhodamine was monitored using a spectrofluorometer at an excitation wavelength of 613 nm and emission wavelength of 554 nm. The sample was replaced in the release medium. The samples were analyzed by fluorescence since sensitivity will be needed for the incoming blood samples analysis.

Results and Discussion

1) Polymer Synthesis

¹H NMR, using a Bruker 400 MHz spectrometer, showed typical spectrum for the triblock copolymer: δ=5.1-5.3 (m, 1H), 4.1-4.4 (m, 2H), 3.4-3.8 (m, 2H), 1.2-1.8 (m; 3H). Molecular weight measured by gel permeation chromatography was around 2000 Da for the triblock copolymer. ¹H NMR of the final multiblock copolymer showed the same spectrum profile as for the triblock but with some extra peaks at 2.8-3.3 ppm and 2.1-2.4 ppm. These peaks can be associated to the adipic acid linked to the triblock copolymer. Molecular weight of the final multiblock copolymer was around 10000 Da.

2) Feasibility of Nanospheres

The suitability of a particular technique for NS preparation is determined mainly by the solubility of the polymer. The most suitable technique for NS preparation from hydrophobic polymers is the organic phase separation and solvent removal technique. The drug is dissolved with the polymer in the organic phase and is emulsified into an external aqueous phase containing a suitable stabilizer. The solvent is then removed from the stable droplets by evaporation (P. B. O'Donnell, and J. W. McGinity, J. Microencapsulation. 13(6): 667-677 (1996); J. Herrmann, and R. Bodmeier, Eur. J. Pharm. And Biom. 45:75-82 (1998)). Several NS manufacturing parameters were studied. First, the composition of the aqueous phase was found to have an influence on the emulsion formation. The required volume of aqueous phase was 500 ml and of the organic phase 10 ml. PVA was used at different concentrations: 0.01; 0.05;0.1 ;0.5; and 1%. The most suitable emulsion with stable droplets was obtained with PVA at 0.1%. As aqueous phase water alone or PEG solution were used, but the obtained emulsion was unstable. Then, some of the manufacturing parameters were optimized as well: sonication time and mode; stirring rate of the emulsion; evaporation period of the solvent; and centrifugation speed. The centrifugation step allowed the obtention of small NS.

3) Size, Zeta Potential, and Morphology

The composition of the NS was varied using different blends of the multiblock and PLA at different percentages as indicated in Table 3.

TABLE 3
physical characteristics of the nanospheres

| NS^{a} composition | Size (nm) ± | ζ (mV) ± | | Loading | Yield |
|---|---|---|---|---|---|
| (Copolymer:PLA) | sd^{b} | sd | SDI^{c} | (%) | (%) |
| 40:60 | 785.0 ± 169.8 | −1.68 ± 0.45 | 0.72 | 7.18 | 65.0 |
| 50:50 | 336.1 ± 92.5 | −1.28 ± 0.75 | 0.89 | 8.75 | 88.3 |
| 60:40 | 513.1 ± 107.9 | −0.64 ± 0.60 | 0.95 | 7.10 | 68.7 |
| 70:30 | 717.3 ± 141.4 | +0.64 ± 0.75 | 1.03 | 6.75 | 80.2 |
| 80:20 | 536.3 ± 42.4 | +0.94 ± 0.45 | 1.12 | 6.25 | 71.0 |
| 90:10 | 560.6 ± 72.5 | +1.10 ± 0.55 | 1.05 | 6.15 | 70.0 |

^{a}NS: nanospheres
^{b}sd: standard deviation (n = 3)
^{c}SDI: size distribution index represents the width of the size distribution.

The multiblock used varied from 40 to 90. The amount of PLA, which confers rigidity, ranged from 60 to 10. The multiblock possess a low Tg value (27° C.), hence the addition of the PLA will be beneficial to increase the Tg value (60° C.). The size of the NS was variable without a specific trend, however all of the NS showed a mean size less than 800 nm. The NS made of 50:50 multiblock-PLA showed the lowest particle size. The ζ potential of the different NS formulations is shown in Table 3. The ζ potential ranges between −1.68 and +0.94. As the concentrations of the copolymer and PEG increase, the ζ potential increases. The average loading of Rhodamine was 7.21±0.94. The loading efficiency decreases with increasing multiblock percentage. The entrapment efficiency was 72.1%, and the average yield was 74.6%.

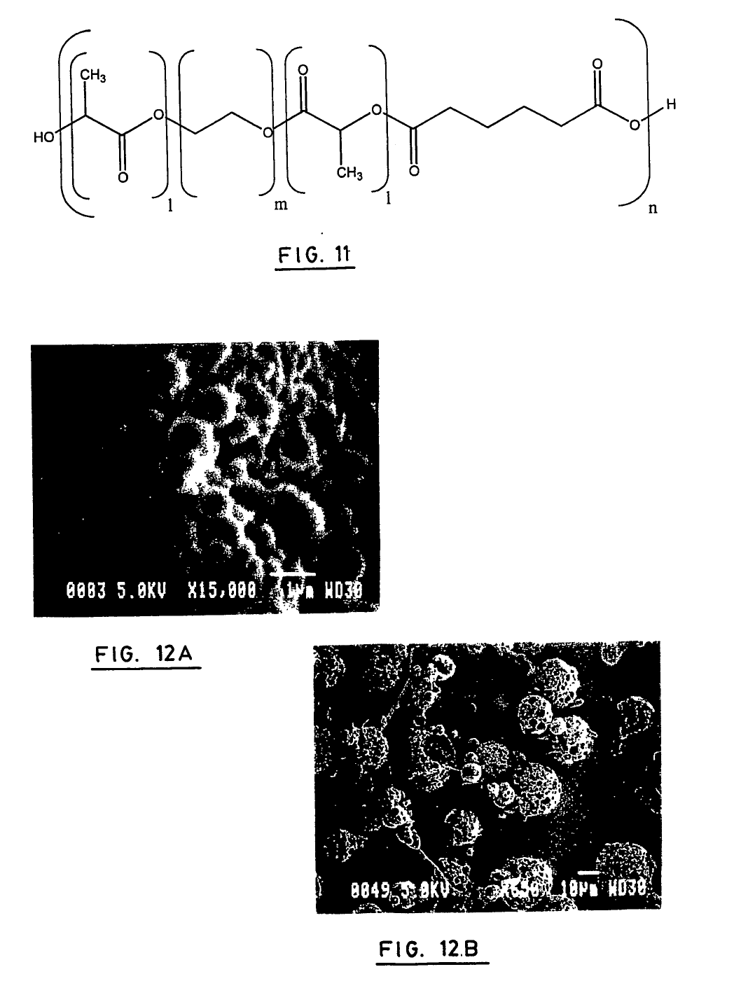

The scanning electron micrographs of the NS showed very spherical particles with a smooth surface in every batch. No visible macropore could be observed. FIG. 12A shows a representative NS micrograph after the release period of 29 days.

4) Degradation Study

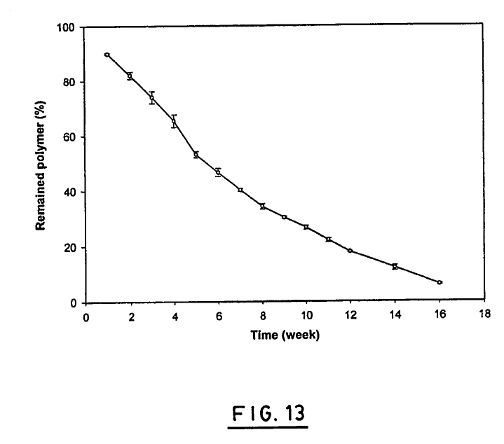

Mass loss of the copolymer in phosphate buffer at 37° C. at pH 7.4 started after 1 week. 50% of the copolymer remained after 5 weeks and a complete degradation was obtained after 16 weeks. This pattern is represented in FIG. 13. The mass loss of the copolymer is due to the hydrolysis of ester bonds and transesterification. Erosion is due to water uptake and scission of the PLA blocks with release of lactide oligomers. FIG. 12B represents a micrograph of NS that underwent degradation in phosphate buffer at 37° C. showing porous structures after the period of release, which is 29 days.

5) Porosity Determination

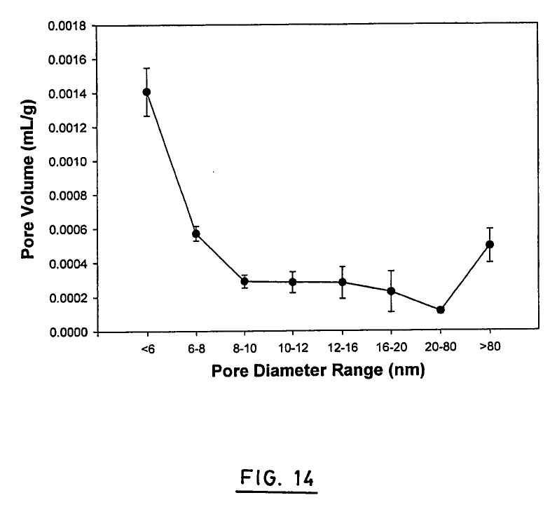

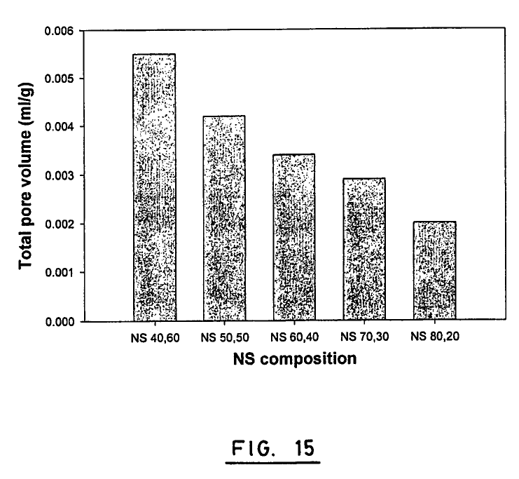

There were no pores observed at the surface of the NS. As shown in FIG. 14, the pore diameter was negligible since the average pore volume in the samples was 0.00597±0.0020 ml/g. Compared to the pore volume (69.25 ml/g) present in the NS made of PLA, the NS made of multiblock (-PLA-PEG-PLA-)ₙ showed very little porosity as presented in the histogram of FIG. 15.

6) Cytocompatibility Studies

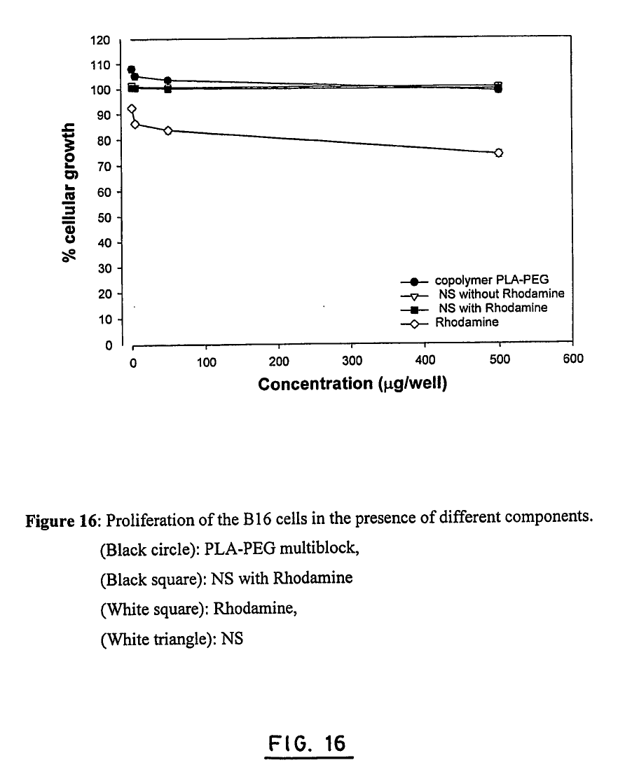

To evaluate the cytocompatibility of the novel copolymer as a drug carrier, different starting materials as monomers and end products, were tested with the B16 cells over several cycles. MTT was used for the assessment of cell proliferation since it measures the cleavage of tetrazolium ring in active mitochondria, so the reaction occurs only in active cells. LDH was monitored as well for the cell viability. The copolymer and its starting synthesis materials showed no inhibition of cell growth. The NS did not influence cell growth. Moreover, Rhodamine enclosed in the NS has no cell growth inhibition while Rhodamine alone showed at high concentration (500 μg/well) inhibition of 25% as shown in FIG. 16. Therefore the encapsulation of Rhodamine in the NS masks the toxicity of Rhodamine. None of the samples showed LDH liberation confirming the cytocompatibility of our biomaterial.

In view of these results, the novel (-PLA-PEG-PLA-)ₙ multiblock copolymer is non-toxic and biodegradable. The multiblock possess the characteristics of both PLA and PEG and offer the possibility of NS preparation as a drug carrier in an advantageous manner, compared to the physical mixture of PLA and PEG, the micelle or the diblock of this copolymer. The size of the NS, the ζ potential, and the use of PEG reinforce the hypothesis of stealth behavior of the NS as it will be shown in an oncoming article.

7) In vitro Drug Release

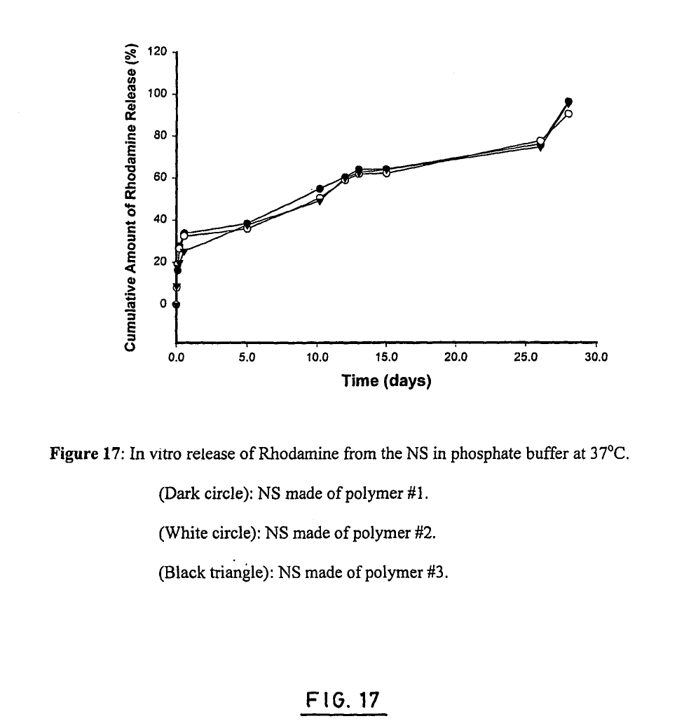

Rhodamine alone exhibited a rapid release within 30 min whereas the Rhodamine loaded into the NS displayed a controlled release as shown in FIG. 17. The release pattern was biphasic. An initial release corresponding to the burst effect of 20% was observed after 5 hours. 50% was released after 10 days and a slow release continued over a period of 27 days. The release pattern was not changed with a change of the NS composition; therefore the release is merely controlled by the copolymer properties. Degradation of the NS in vitro (controlled mainly by erosion) was slow.

As the NS showed a protection of cells against Rhodamine toxicity, it will be interesting to investigate the in vivo release, as well as the fate of the NS against the phagocytic cells which will be the next step of the study.

Conclusions

A novel multiblock copolymer (-PLA-PEG-PLA-)ₙ was successfully synthesized and its cytocompatibility were assessed. The in vitro degradation of the copolymer was determined as well. A rapid and simple modified solvent evaporation technique was developed for NS preparation from the multiblock copolymer. Neutral NS with size less than 800 nm were obtained. Rhodamine B release from the NS showed a sustained release over a period of 29 days with a biphasic pattern. Consequently, a new biodegradable and cytocompatible drug vehicle was developed that is a promising injectable arsenal for controlled drug delivery.

### Example 3

### In vivo Properties of (PLA-PEG-PLA)ₘ Nanospheres as a Drug Carrier

Introduction

Intravenous injection must be done by the use of particles smaller than 1 μm. On the other hand, smaller are the particles higher are the elimination, the aggregation and faster is the release of drug. The nanoparticles described here have been developed to avoid these inconveniencies. The polymer synthesis and the drug carrier preparation have been described elsewhere. Briefly, the polymer is a multiblock copolymer, where blocks of PLA and blocks of PEG alternate. The nanospheres have been prepared by an emulsion-solvent evaporation method using a continuous flow ultrasound homogenizer. Release profile, cytocompatibility, degradation, and pharmacokinetics have been described previously. In vitro and in vivo release profile demonstrate a three-step release with peaks at 25, 250 and 500 hours. This particular mechanism is clearly related to drug carrier properties, but the behavior after injection had to be studied more deeply. Specially, the interactions of nanospheres with blood cells and plasma proteins have to be studied. Moreover, the possible accumulation of nanospheres in RES organs has to be determined.

Material and Methods

Rhodamine B was encapsulated in nanospheres by a solvent-evaporation method. The percentage of proteins bound to the nanospheres was determined using a Bicinchonic <<Protein Reagent Assay>>.

In vivo experiments have been done on Charles-River male rats. (25) Rats were injected with nanospheres containing rhodamine on marginal tail vein. 0.5 ml was taken at each time step. Plasma levels of rhodamine were measured by fluorescence detection. For each time step, rats were killed and organs were taken and frozen. Slices of liver, spleen, kidneys, heart and lungs were taken and fixed by a cryogenic method. Organs were examined by fluorescence microscopy. Images were grabbed by an Axiovert™ Zeiss microscope that is mounted with a digital camera. Images fluorescence intensity was measured using an image analysis software (Optimas™ v5). Intensity was compared to a control (free rhodamine) and to a blank sample (no rhodamine and no nanosphere).

Nanospheres Properties

Nanospheres size and morphology have been evaluated by AFM microscopy (Digital Instrument). Nanospheres were mounted on a tape fixed to a metallic cylinder. Contact mode, tap mode and phase mode were used. Porosity has been determined using a gas adsorption Coulter SA3100™.

Flow Cytometry

At predetermined time intervals, blood samples were treated as follow: EDTA (10 mmol/L) and rat CD-15 antibodies were added to blood samples; then, a lysing solution was used prior to analysis. The phagocytic cell lines were identified using laser light at 488 nm. The number of nanospheres phagocyte was calculated as well.

Results and Discussion

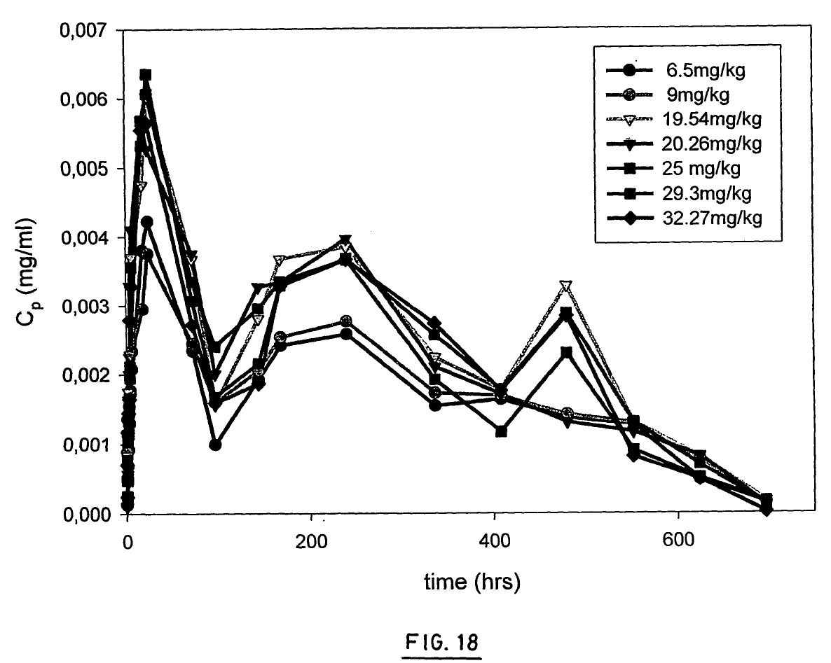

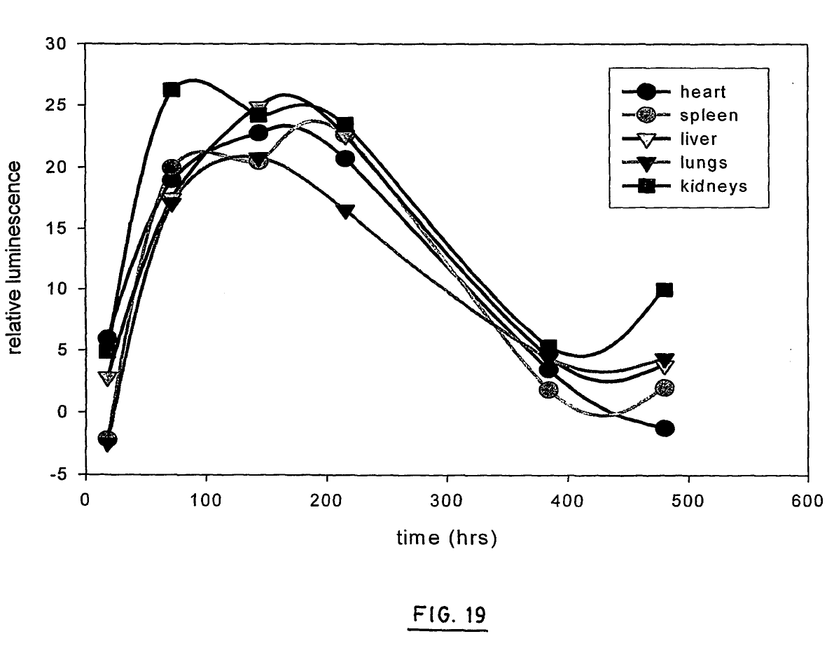

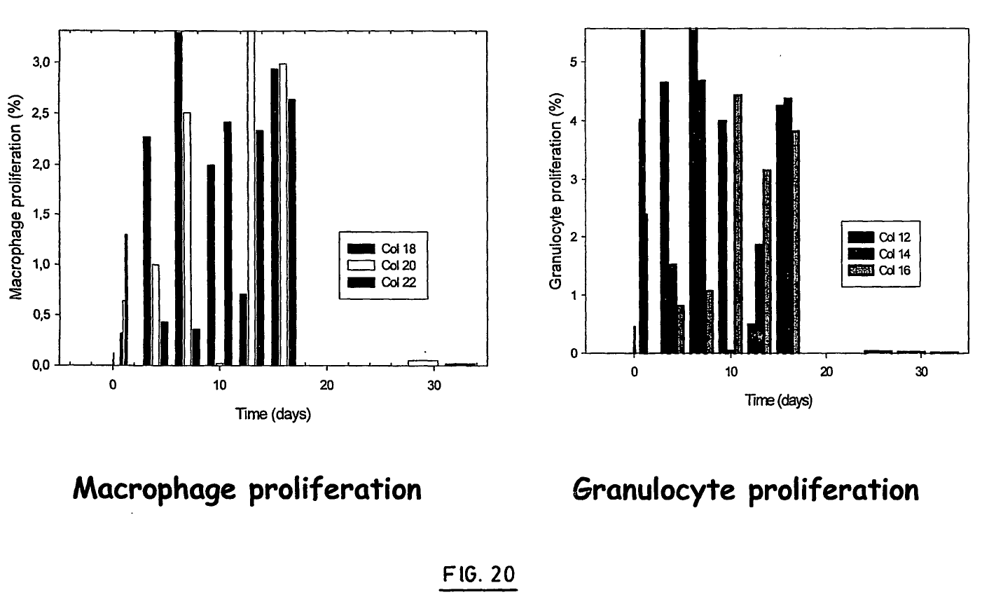

The binding of nanospheres to the plasma proteins was negligible. The average size of nanospheres was 600 nm determined by two methods: AFM microscopy and photon correlation. Cytocompatibility studies showed no proliferation of phagocytic cell lines in the peritoneal liquid of rats, neither in vitro NO liberation by the macrophages. The in vivo pharmacokinetics revealed a controlled release of rhodamine from nanospheres starting at day 3, and a steady release was achieved over a period of 29 days (see FIG. 18). By following the rhodamine concentration in organs at different times, we confirmed the controlled release of the drug over a time superior to lifetime of rhodamine (t_{1/2}=3 hrs) in the body. No nanosphere accumulation can be seen after 10 days in the examined tissues (see FIG. 19). There was no obvious concentration of nanospheres in reticulo-endothelial system and in macrophages (now shown). It is a confirmation of long circulation nature of this type of drug carrier. Furthermore, no interaction of nanospheres with blood phagocytic cell lines was observed with flow cytometry (see FIG. 20).

AFM Picture of Nanospheres

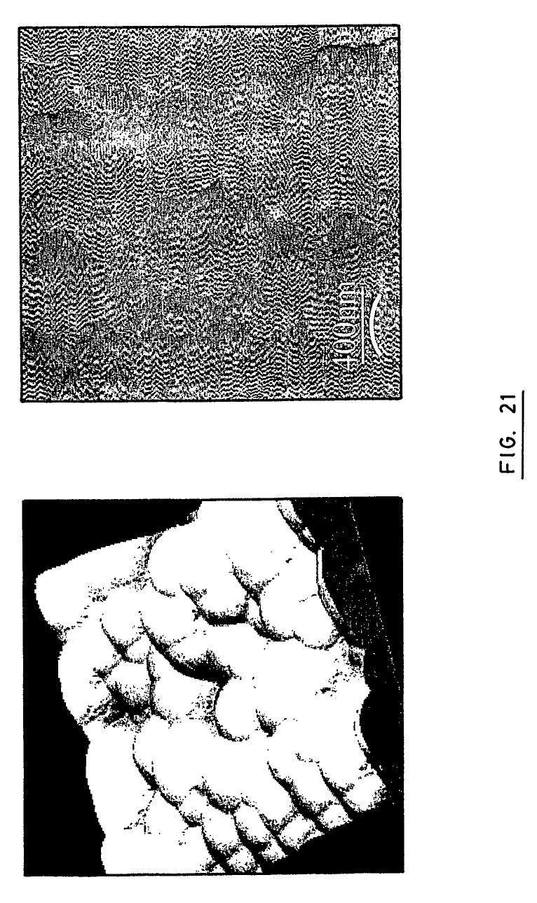

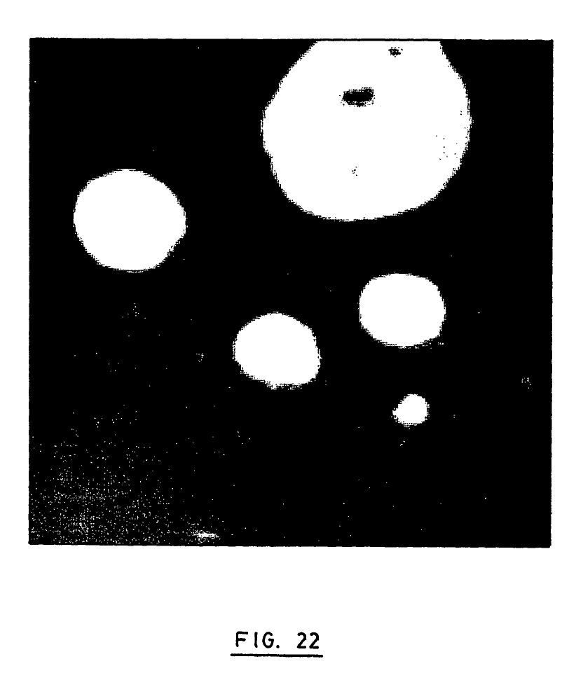

As shown in FIG. 21, nanospheres surface was smooth. The average distance between the nanospheres was 240 nm. The average roughness was 16.3 nm. Phase analysis in water showed clearly the regions of PEG blocks concentrated on the surface of nanospheres (See FIG. 22).

Image Analysis

No Rhodamine accumulation could be observed in the organs. Rhodamine concentration follows the plasmatic level.

Conclusion

This study demonstrates the potential of (PLA-PEG-PLA)ₙ nanospheres as an intravenous drug carrier. The stealth behavior of the nanospheres is emphasized by the presence of the hydrophilic component (PEG) in the multiblock. Finally, a controlled release is achieved. The protective effect of PEG in the nanospheres prevented phagocytosis, as longevity in blood circulation was ascertained.

### Example 4

### Comparative Physico-Chemical Study of Nanospheres made of Biodegradable Polymers

Introduction

Controlled release of therapeutic agents is one of the primary objectives in drug formulation. New dosage forms aim to improve drug delivery by means of vectors which offer a targeted action and/or a prolonged biological effect. Polymeric colloidal drug carriers have been of great interest for the preparation of controlled release dosage forms designed for both parenteral and non-parenteral delivery. They are made of natural or synthetic polymers which are biodegradable and biocompatible such as Poly(D,L-lactic acid) and its copolymer with glycolic acid, poly(lactide-co-glycolide). Polymeric nanospheres and microspheres have particularly received much attention as drug carriers. They can be prepared according to different methods, the most common being spray-drying [J. of Microencapsulation, 2000. 17(4): p. 485-498] and double emulsion [Journal of Drug Targeting, 1999. 7(4): p. 313-323].

The objective of this work was to prepare nanospheres using different biodegradable polymers, and to study their physico-chemical characteristics such as size, surface area, porosity and surface structure, in order to select the most suitable formulation for microencapsulation of a plasmid DNA.

Experimental Methods

Materials

PLGA M_{w} 48000 RG 504 was purchased from Boehringer Ingleheim. PLA, triblock (PLA-PEG-PLA) and multiblock (PLA-PEG-PLA)ₙ copolymers were synthesized in the laboratory. Sorbitol was purchased from Laboratoires Denis Giroux, Inc.

Preparation of Nanospheres

Nanospheres were prepared according to an original double emulsion method w/o/w (previously described). Different batches were prepared using different polymers: PLGA, PLA, triblock, multiblock, PLA-multiblock physical mixture, three additional batches made of PLGA were stabilized with 0.5%, 1% and 5% sorbitol respectively.

Surface Morphology

Scanning Electron Microscopy

Nanospheres were examined using a Jeol SEM at a voltage of 1.0 KV. No coating was performed prior to scanning.

Atomic Force Microscopy

Nanospheres were fixed on a double-sided adhesive tape. AFM images were obtained by a Nanoscope Dimension 3100™ (Digital Instruments) in tapping mode.

Particle Size Determination

Particle size distribution was determined using photon correlation spectroscopy (Nanosizer N4 Plus™, Coulter Electronics)

Porosity and Surface Area Determination

Specific surface area and porosity were determined by nitrogen adsorption using a Surface Area Analyzer (Coulter SA 3100™, Coulter Electronics)

Results and Discussion

Surface Morphology

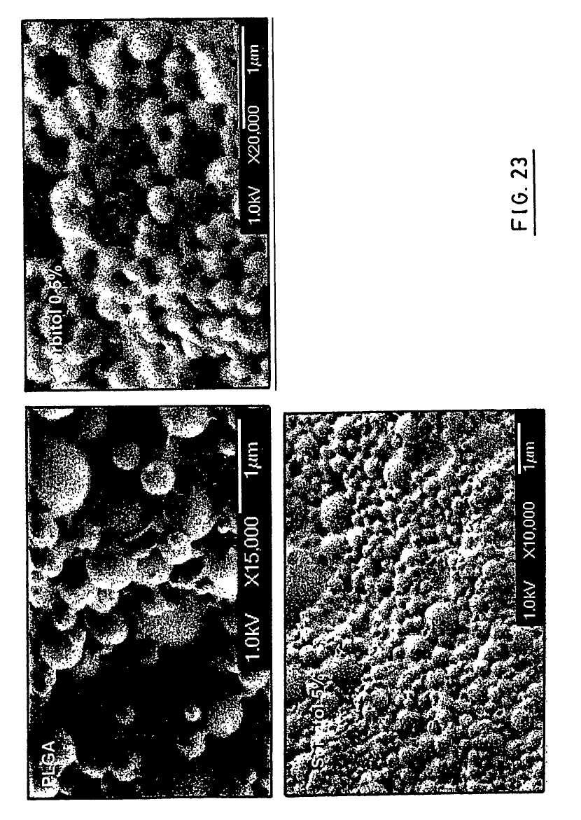

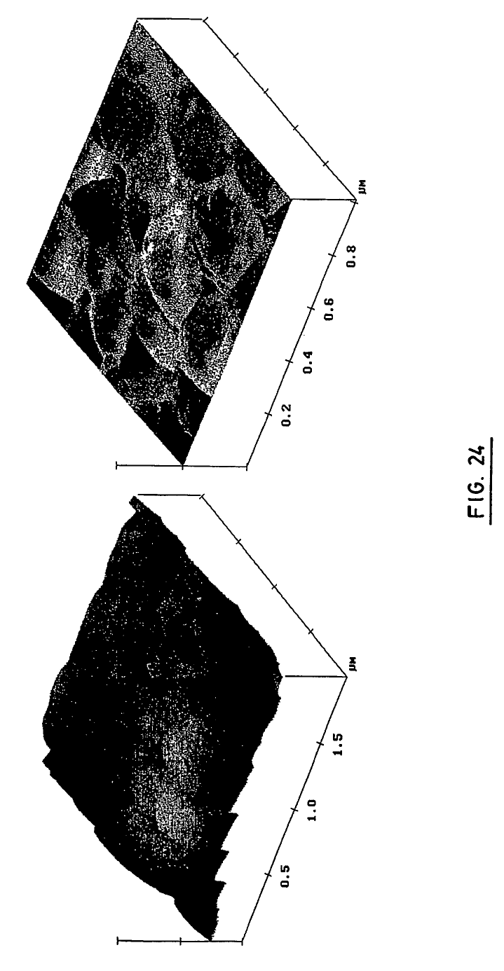

From scanning electron microscopy, nanospheres appeared to be round in shape with smooth surface and their particle size was ranging from 250 to 600 nm (FIG. 23). More detailed morphology of nanospheres was obtained in AFM images (FIG. 24).

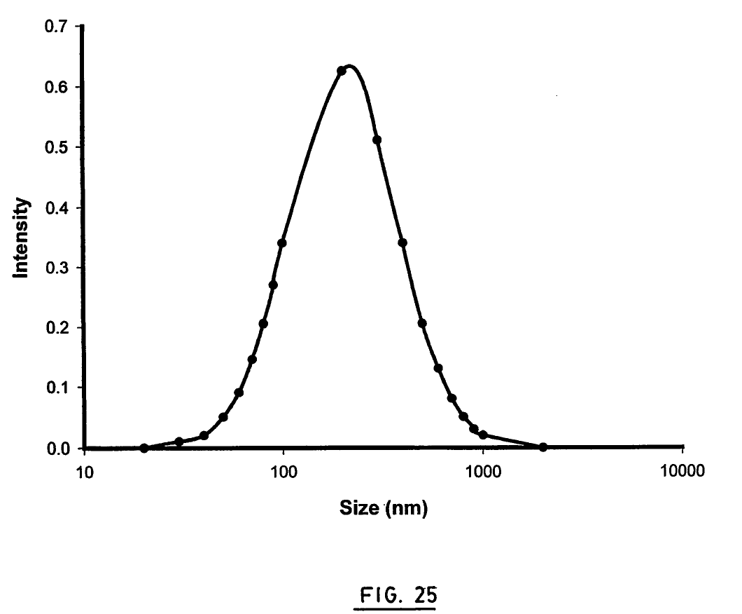

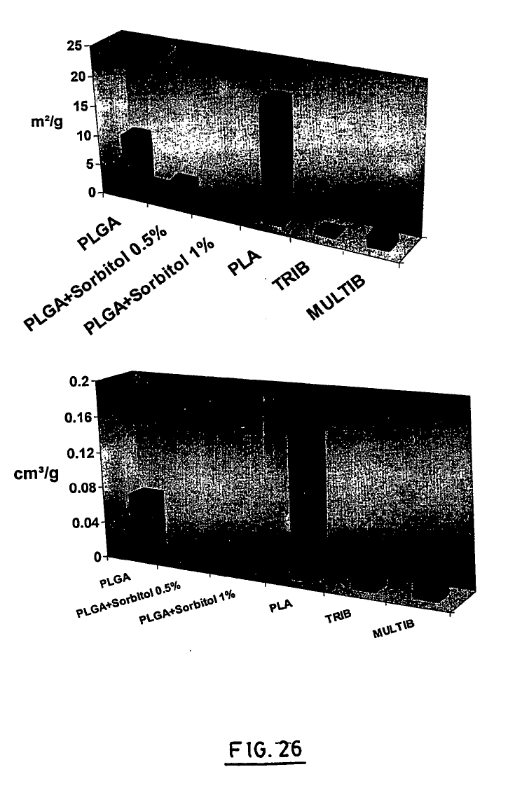

FIG. 25 shows particle size distribution of PLGA nanospheres obtained by photon correlation spectroscopy. Mean particle size was about 286±66 nm. No significant difference in particle size was observed for nanospheres obtained from different polymers, proving that the particle size was dependant on the preparation conditions rather than the polymer used.

Surface Area and Porosity

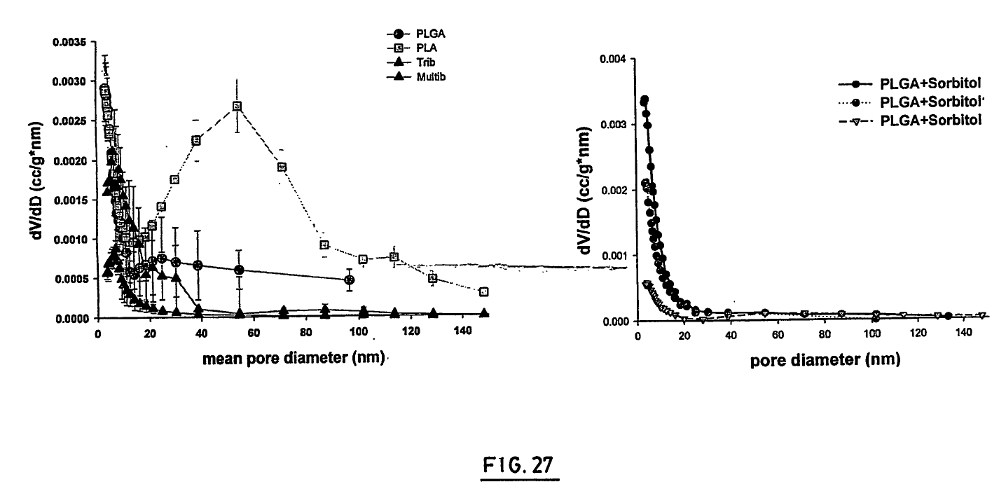

Values of surface area and porosity were influenced by the polymer. PLA nanospheres show the highest surface area and highest porosity (FIG. 26). Batches of PLGA nanospheres cryoprotected with sorbitol demonstrate reduced porosity with respect to unprotected PLGA nanospheres (FIG. 26). This is due to sorbitol which becomes precipitated on nanospheres during freeze-drying.

FIG. 27 shows pore size distribution of PLGA, PLA, Triblock and Multiblock nanospheres (left), and for PLGA nanospheres protected with 0.5%, 1% and 5% sorbitol respectively (right). A larger number of small pores refers to a more complex porous network. These results suggest that, as concentration of sorbitol increases, small pores become blocked.

Transfection of Cells with the Nanospheres

Although not shown, preliminary results confirmed that the nanospheres of the invention are capable of incorporating and delivering DNA into cells. Indeed, we were able to incorporate a plasmid DNA coding for the luciferase gene into the nanospheres (made of multiblock and PLGA by the double emulsion technique) and transfect cos-7 type cells in vitro by contacting these cells with the DNA-loaded nanospheres. Enzymatic activity was detected within the cells confirming that the cos-7 cells were efficiently transfected and that the luciferase gene incorporated and delivered by the nanospheres was functional.

Conclusion

The w/o/w method used was successful to obtain nanospheres with appropriate particle size (<1 μm). The presence of sorbitol as stabilizer for nanospheres improved the quality of the final product but it decreased its porosity. The results obtained also confirm that the nanospheres are a suitable carrier for delivering a gene of interest into mammalian cells.

While several embodiments of the invention have been described, it will be understood that the present invention is capable of further modifications, and this application is intended to cover any variations, uses or adaptations of the invention, following in general the principles of the invention and including such departures from the present disclosure as to come within knowledge or customary practice in the art to which the invention pertains, and as may be applied to the essential features hereinbefore set forth and falling within the scope of the invention.

1. Stealthy polymeric biodegradable nanospheres each comprising:
(i) a polyester-polyethylene multiblock copolymer;
(ii) optionally a polyester entangled with the multiblock copolymer to give rigidity to the nanospheres; and
(iii) optionally a pharmaceutical compound incorporated therein.

2. The stealthy polymeric biodegradable nanospheres according to claim 1, wherein said nanospheres comprise:
from 0.1% to 100% of the polyester-polyethylene multiblock copolymer;
from 0% to 99% of the polyester; and
from 0.1% to 20% of the pharmaceutical compound.

3. The stealthy polymeric biodegradable nanospheres according to claim 1, wherein the polyester-polyethylene multiblock copolymer comprises a series of polyester and polyethylene blocks which alternate so as to form a repetitive sequence.

4. The stealthy polymeric biodegradable nanospheres according to claim 3, wherein the polyester-polyethylene multiblock copolymer is of the formula (I).
ABA-(c-ABA)ₙ-c-ABA (I)
wherein
n is a number equal or greater than 2;
ABA is a PLA-PEG-PLA triblock; and
c is a carboxylic diacid.

5. The stealthy polymeric biodegradable nanospheres according to claim 4, wherein the ABA triblock is of the formula (VII): 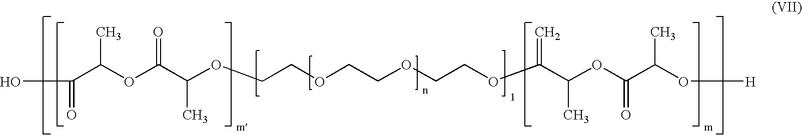
wherein n and m are numbers equal to or greater than 1.

6. The stealthy polymeric biodegradable nanospheres according to claim 4, wherein the carboxylic diacid is selected from the group comprising of butanedioic acid, propanedioic acid and pentanedioic acid.

7. The stealthy polymeric biodegradable nanospheres according to claim 3, wherein the multiblock copolymer is of the formula (III):
ABA-B′-(ABA-B′)ₙ-ABA (III)
wherein
A is a polyester,
B is a polyethylene;
B′ is a dicarboxylic polyethylene; and
n is a number equal to or greater than 2.

8. The stealthy polymeric biodegradable nanospheres according to claim 7, wherein the polyester is selected from the group consisting of polylactic acid (PLA), polylactic-co-glycolic acid (PLGA), polycaprolactone (PCL), and polyhydroxy butyrate.

9. The stealthy polymeric biodegradable nanospheres according to claim 8 wherein the polyester is a polylactic acid (PLA).

10. The stealthy polymeric biodegradable nanospheres according to claim 7 wherein said polyethylene is a polyethylene oxide (PEO).

11. The stealthy polymeric biodegradable nanospheres according to claim 10, wherein the polyethylene oxide (PEO) is a polyethylene glycol (PEG).

12. The stealthy polymeric biodegradable nanospheres according to claim 7, wherein the dicarboxylic polyethylene is selected from the group of dichloride dicarboxylic (PEG) and dibromide dicarboxylic PEG.

13. The stealthy polymeric biodegradable nanospheres according to claim 1, wherein the polyester (ii) is selected from the group consisting of polylactic acid (PLA), polylactic-co-glycolic (PLGA), polycaprolactone (PCL) and their copolymers.

14. The stealthy polymeric biodegradable nanospheres according to claim 13, wherein the polyester (ii) is polylactic acid (PLA).

15. The stealthy polymeric biodegradable nanospheres according to claim 1, wherein the pharmaceutical compound (iii) is a drug, a protein and/or a nucleic acid molecule for the prevention or treatment of various diseases and/or delivery of different types of therapeutic agents.

16. The stealthy polymeric biodegradable nanospheres according to claim 15, wherein the therapeutic agents are selected from the group consisting of anticancer agents, immunosuppressive agents, agents for steroid therapy, anti-arrhythmic agents, antibiotics, antiparasitics, antivirals, antifungics, gene-therapy agents, antisense molecules, orphan drugs, and vitamins.

17. The stealthy polymeric biodegradable nanospheres according to claim 1, wherein the nanosphere has an average size of less than 800 nm.

18. The stealthy polymeric biodegradable nanospheres according to claim 17, wherein the average size is about 200 nm to 5 μm.

19. The stealthy polymeric biodegradable nanospheres according to claim 17, wherein the average size is about 100 nm to 10 μm.

20. The stealthy polymeric biodegradable nanospheres according to claim 1, wherein the nanosphere has a zeta potential close to 0 mV.

21. Use of stealthy polymeric biodegradable nanospheres according to claim 1 for the preparation of a medicament having a long term, controlled and non-toxic release of a pharmaceutical compound into a mammal.

22. A polyester-polyethylene multiblock copolymer of formula (III):
ABA-B′-(ABA-B′)ₙ-ABA (III)
wherein
A is a polyester;
B is a polyethylene;
B′ is a dicarboxylic polyethylene; and
n is a number equal or greater than 2.

23. The polyester-polyethylene multiblock copolymer according to claim 22, wherein the polyester is selected from the group consisting of polylactic acid (PLA), polylactic-co-glycolic acid (PLGA), polycaprolactone (PCL), and polyhydroxy butyrate.

24. The polyester-polyethylene multiblock copolymer according to claim 22, wherein the polyester consists of polylactic acid (PLA).

25. The polyester-polyethylene multiblock copolymer according to claim 22, wherein the polyethylene is a polyethylene oxide (PEO).

26. The polyester-polyethylene multiblock copolymer according to claim 25, wherein the polyethylene oxide (PEO) is a polyethylene glycol (PEG).

27. The polyester-polyethylene multiblock copolymer according to claim 22, wherein the dicarboxylic polyethylene is selected from the group consisting of dichloride dicarboxylic (PEG) and dibromide dicarboxylic PEG.

28. A method for preparing the polyester-polyethylene multiblock polymer of formula (III) as defined in claim 22, comprising the steps of:
a) oxidizing both terminal hydroxyl groups (—OH) of a polyethylene glycol into corresponding carboxylic groups (COOH) by means of a Jones reaction;
b) chlorinating the carboxylic functions of the polyethylene glycol obtained in step a) by making use of a SOCI₂ reagent so as to obtain a polyethylene glycol with terminal dichloride acid functions; and
c) reacting the polyethylene glycol having terminal dichloride acid functions obtained in step b) with the PLA-PEG-PLA triblock polymer of formula (I):
ABA-(c-ABA)ₙ-c-ABA (I)
wherein
n is a number equal or higher than 2;
ABA is a PLA-PEG-PLA triblock; and
c is a carboxylic diacid; and
said method comprising the steps of:
a) preparing a PLA-PEG-PLA triblock;
b) mixing the PLA-PEG-PLA triblock prepared in step a) with a diacid selected from the group consisting of propanedioic acid, butanedioic acid and pentanedioic acid by making use of polycondensation reaction so as to obtain a multiblock copolymer comprising a series of polyester and polyethylene blocks which alternate so as to form a repetitive sequence.

29. An improved method for preparing a PLA-PEG-PLA multiblock copolymer of formula (I):
ABA-(c-ABA)ₙ-c-ABA (I)
wherein
n is a number equal or higher than 2;
ABA is a PLA-PEG-PLA triblock; and
c is a carboxylic diacid.
said method comprising the steps of:
a) preparing a PLA-PEG-PLA triblock;
b) mixing the PLA-PEG-PLA triblock prepared in step a) with a diacid of formula (II): 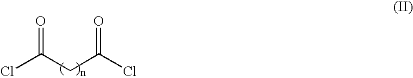
wherein n is a number equal to or greater than 1; and
c) subjecting the mixture of step b) to a polycondensation reaction with the presence of a dicyclohexylcarboxydiimide reagent and/or a chemical equivalent thereof, said catalyst improving the efficiency of the reaction, thereby allowing to obtain the requested multiblock copolymer.

30. The method according to claim 29, wherein step a) comprises the steps of:
(i) reacting at least one monomer A with at least one monomer B by a polycondensation reaction so as to produce a PLA-PEG-PLA triblock;
(ii) dissolving the PLA-PEG-PLA triblock obtained in step (i) in acetone;
(iii) precipitating the dissolved PLA-PEG-PLA triblock in step (ii) in water; and
(iv) washing and drying the PLA-PEG-PLA triblock polymer.

31. The method according to claim 30, wherein monomer A is selected from the group comprising of dioxanediones, lactones and dioxanones.

32. The method according to claim 30, wherein monomer B is a polyethylene glycol (PEG) represented by the formula (B): 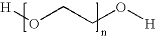
wherein n represents a number between 200 and 2000.

33. The method according to claim 30, wherein step (ii) is carried out with a tin based catalyst at a temperature between 160° C. and 180° C. under an inert atmosphere.

34. The method according to claim 29, wherein the diacid chloride used in step b) is selected from the group comprising of propanedioic acid, butanedioic acid and pentanedioic acid.

35. The method according to claim 29, wherein the chemical equivalent of dicyclohexylcarboxydiimide (DCC) is 1-(3-dimethylaminopropyl)-3-ethylcarbodiimide (EDC).

36. The method according to claim 29, wherein the carboxylic diacid in step c) is selected, the group comprising of butanedioic acid, propanedioic acid and pentanedioic acid.

37. A method for delivering a pharmaceutical compound into a mammal, said method comprising the step of: administering to the mammal a stealthy polymeric biodegradable nanosphere as claimed in claim 1 loaded with a therapeutically effective amount of the pharmaceutical compound.

38. The method according to claim 37, wherein the pharmaceutical compound comprises a therapeutic agent which is selected from the group of anticancer agents, immunosuppressive agents, agents for steroid therapy, anti-arrhythmic agents, antibiotics, antiparasitics, antivirals, antifungics, gene-therapy agents, antisense molecules, orphan drugs, and vitamins.

39. The method according to claim 37, further comprising other agents allowing for a targeted delivery of the pharmaceutical compound into the mammal.

40. The method according to claim 39, wherein the other agent is an antibody.

41. Method for preparing stealthy polymeric biodegradable nanospheres from an emulsion, the method comprising the step of:
(i) prepraring an organic internal phase comprising a pharmaceutical compound, a polyester-polyethylene multiblock as defined in claim 3 and/or a blend of polymers and a polyester;
(ii) preparing an aqueous external phase;
(iii) injecting both the organic internal phase of step (i) and the aqueous external phase of step (ii) into a homogenization chamber having an outlet, with or without a surfactant, thereby producing an emulsion at the outlet of the chamber;
(iv) evaporating and/or extracting the phases of step (iii) so as to produce stealthy polymeric nanospheres; and
(v) collecting the stealthy polymerice nanospheres obtained in step (iv) by centrifugation or dialysis.

42. Method according to claim 41, wherein a primary emulsion is used instead of the organic phase of step (i) when the pharmaceutical compound a hydrophilic drug.

43. Method according to claim 42, wherein the primary emulsion is obtained by dispersing an aqueous solution into an organic solution containing polymers.

44. Method according to claim 41, wherein the blend of polymers is a multiblock polymer mixed with a polyester selected from the group comprised of PLA, PCL and PLGA.
